(19) United States
(12) Patent Application Publication
(10) Pub. No.: US 2025/0145474 A1
(43) Pub. Date: May 8, 2025

(54) NANO SILICON PARTICULATES AND METHOD TO MAKE THEM

(71) Applicant: Advano, Inc., New Orleans, LA (US)

(72) Inventors: Gregory Alan Marus, San Jose, CA (US); Meysam Shahami, Mount Holly, NC (US); Saheem Absar, New Orleans, LA (US); Brandon Dang, Harvey, LA (US)

(21) Appl. No.: 18/838,906

(22) PCT Filed: Mar. 1, 2023
(86) PCT No.: PCT/US2023/014282

§ 371 Date: Aug. 15, 2024

Related U.S. Application Data
(60) Provisional application No. 63/444,479, filed on Feb. 9, 2023.
(60) Provisional application No. 63/315,244, filed on Mar. 1, 2022.

(51) Int. Cl. C01B 33/021

(52) U.S. Cl. CPC C01B 33/021; C01P 2002/82; C01P 2002/85; C01P 2004/03; C01P 2004/51; C01P 2004/61; C01P 2004/84; C01P 2006/12; C01P 2006/40

(57) ABSTRACT

Nanosized silicon or alloys thereof are formed by milling in solvents comprising at least one polar protic solvent (e.g., an alcohol) or polar aprotic solvent (e.g., a nitrile) where the average milling media size is at least about 5 times to 200 times larger than the initial average silicon particle size. The method more efficiently mills silicon and achieves smaller nanosized particles with less input power or time and stable dispersions in the absence of a surfactant allowing for the direct formation of secondary particles. The milled silicon particles are useful as electrodes in electrical devices such as batteries.

### FIELD

The disclosure relates to a method of making nanometer scale particles comprised of silicon for use in batteries. In particular, the method makes silicon containing particles having an average size of less than 100 nanometers for use in lithium ion secondary batteries.

### BACKGROUND

Lithium ion secondary batteries typically have been formed using a metal oxide or metal phosphate particulate cathode and a graphitic particulate anode. Anodes of lithium metal that have higher capacity than graphite have been pursued but have not met with success due to safety concerns such as dendritic growth from the anode that short circuits the battery. Silicon, which has a much higher lithium insertion capacity than graphite (i.e., 4,212 mAh/g versus 372 mAh/g) are being pursued, but have had limited success due to volumetric expansion arising from the insertion of lithium in the silicon structure causing electrical disconnection within the anode reducing the charge capacity substantially.

To ameliorate the problem of the excess nano particles formed by expensive vapor depositions have been employed to make nano-particles, which then are incorporated into an anode with a binder reducing the tendency to cause electrical disconnection within the anode. Unfortunately, the production of nano sized silicon particles has tended to increase the formation of silicon oxide species minimizing the advantages of silicon due to decreased capacity and formation of high dielectric constant surface layer. To remedy these problems, previous work has focused on forming nano-silicon particles in inert atmospheres such as hydrocarbon solvents (oxygen and water free) and reacting the formed surfaces with a reactive species to minimize the reaction of the silicon surface with oxygen (passivation of the surface) such as described by U.S. Pat. Nos. 7,371,666; 9,461,309 and 10,211,454. However, these have reported difficulty in reducing the size below 100 nm in benzene as well as agglomeration being a problem (i.e, slurry instability).

Accordingly, it would be desirable to provide a method of forming silicon particles that avoids one or more of the problems of the prior art such as inability to form silicon particles below 100 nm that that remain dispersed without agglomerating as well as being able to be co-produced with other desirable components of a silicon containing anode.

### SUMMARY

Applicant has surprisingly discovered that silicon or silicon alloy particulates less than 100 nm having higher surface area may be formed in protic or aprotic polar solvents having a dielectric constant of at least about 10 without increasing the oxygen content of the formed silicon particulates even in the presence of oxygen in the solvent or water present in the solvent compared to milling in water insoluble hydrocarbon solvents. That is, the oxygen content for a similarly milled silicon in a hydrocarbon solvent with essentially at most trace amount of water has essentially the same amount of oxygen even though the surface area is essentially the same and the volume of particles less than 100 nm is greater. The method also may realize the formation of a stable dispersion of the silicon containing particulates in the absence of a surfactant. The method may also form a stable dispersion of silicon containing particles with other useful components for making battery electrodes or the like such as carbon particulates. The method may also form silicon particulates wherein the silicon particulates have an oxide surface that is comprised of a desirable SiOₓ/SiO₂ weight ratio and where x is less than 2 (“silicon suboxide”).

An illustration is a method to form particles comprising:
(i) dispersing initial particles comprised of silicon in a solvent comprising a polar protic solvent, an aprotic polar solvent or combination thereof to form a slurry, and
(ii) milling the initial particles comprised of silicon in the slurry with milling media to formed milled silicon particles, wherein the initial particles and the milling media each have an average particle size and the average size of the milling media to average size of the initial particles is at least about 5 to about 100.

It has been discovered that solvents comprised of a nitrile improves the Si milling and, secondary particle made with the milled Si and anodes made therefrom. Surprisingly, the Si powder after evaporation of the solvent comprised of the nitrile (e.g., benzonitrile) results in a deagglomerated powder not requiring any subsequent grinding, before being formed into a secondary particle comprised of the silicon. Such milled silicon powders retain the nitrile on the surface even when dried above its boiling point under vacuum such as by rotary evaporation (down to ˜1 to 30 Torr) for 12 hours as determined by Fourier transform infrared spectroscopy (FTIR) and X-ray photoelectron spectroscopy (XPS). This tenacity to remain bonded is referred to herein as chemisorbed and without being limiting, is believed to be due to the formation of a ligand between the newly cleaved silicon particle surfaces and the nitrile. This behavior was not displayed by silicon milled in solvent not having a nitrile solvent. It was also not displayed when the milled silicon was mixed with a nitrile solvent after milling in a solvent that was not a nitrile such as when forming a secondary particle.

The milled silicon powder may have the solvent removed by any method as described herein, and illustratively, the solvent may be removed after separation of the milling media with the addition of any useful solvents to adjust the characteristics of the milled silicon slurry to make secondary particles such as spray drying. For example, the solvent used during milling may preferentially remove a low boiling point solvent (herein one having a boiling point “BP” below water's BP such as an alcohol like isopropyl alcohol) to concentrate the high BP solvent such as an aromatic nitrile and increase the solids loading to more efficiently spray dry and/or improve the dissolution of one or more carbon forming materials (e.g., pitch).

The presence of the nitrile has been observed to improve the formation of secondary particles comprised of two or more carbon forming materials that dissolve in a solvent used to make the secondary particles (e.g., spray drying). Desirably, when two carbon forming materials are present, each of them forms a differing form of carbon (e.g., pitch and phenolic resin) when pyrolyzed. The solvent when forming the secondary particle may be comprised of a nitrile such as in spray drying. Such secondary particles when pyrolyzed to form Si—C composite particles that are used in an anode in a battery have been found to exhibit longer cycle life. These Si—C composite particles are believed to have enhanced properties due to the presence of the chemisorbed nitrile when forming the composite particles. That is the silicon particles of the composite particles may have a nitrile residue.

An illustration is a composition comprising a stable dispersion comprised of particulates comprised of silicon dispersed in a solvent comprised of a polar protic solvent, polar a protic solvent or combination thereof. “Stable” herein means that the dispersion of the particles comprised silicon in the absence of agitation fail to display any separation by eye of particles due to settling for 24 hours or more.

An illustration is a composition comprising particulates comprised of silicon, said particulates having a surface area of at least 30 m²/g to 150 m²/g, the particulates being individual particles having an amount of oxygen by weight where the amount of oxygen by weight/surface area is a ratio of 0.3 to 0.1. Surprisingly, the amount of oxygen when milling in a protic polar solvent realizes a ratio of oxygen essentially the same compared to solvents that do not contain oxygen (e.g., benzene and hexane) and are insoluble with water. It is unclear why this occurs, but without being limiting in any way, may be that such solvents even though intended to limit the oxygen content appear to form differing Si—O species (i.e., differing ratios of SiOₓ/SiO₂). The silicon of this aspect and the silicon produced by the method of this invention may be used to form an electrode, which may be incorporated into an electrical device such as a battery.

In an illustration, a powder composition comprises a silicon powder (such as those milled Si particles described herein) having thereon a chemisorbed nitrile. In another illustration, a secondary particle is comprised of a silicon powder having a nitrile chemisorbed thereon and a carbon forming material. A further illustration is a composite particle comprising silicon powder and carbon, wherein the carbon is a continuous matrix having the silicon powder dispersed therein and the composite particle has a Raman D/G ratio of at most about 1, 0.95, 0.9, 0.85, or 0.8. The D/G ratio arises when a sufficient amount (e.g., at least 5%, 10% or 15% by weight) of a nitrile solvent (e.g., aromatic nitrile) is present in the spray drying solvent. The D/G ratio may be determined as described by Characterizing Carbon Materials with Raman Spectroscopy, Joe Hodkiewicz, Thermo Scientific Application Note: 51901 or A. C. Ferrari and J. Robertson, Phys. Rev. B 61, 14095, May 2000

### BRIEF DESCRIPTION OF THE DRAWINGS

FIG. 1 is a scanning electron micrograph (SEM) of the milled silicon of this invention.

FIG. 2 is a SEM of milled silicon not of this invention.

FIG. 3 is a particle size distribution plot of the milled silicon of this invention.

FIG. 4 is a particle size distribution plot of milled silicon not of this invention.

FIG. 5 is a plot of the D50 size versus mill energy input of silicon milled by a method of this invention.

FIG. 6 is a plot of the D50 size versus mill energy input of silicon milled by a method not of this invention.

FIG. 7 is a X-ray photoelectron spectra (XPS) of milled silicon of this invention.

FIG. 8 is a XPS spectra of milled silicon not of this invention

FIG. 9 is a particle size distribution plot of the milled silicon of this invention as a function of mill time.

FIG. 10 is a particle size distribution plot of the milled silicon of this invention as a function of mill time.

FIG. 11 is a particle size distribution of the milled silicon of this invention.

FIG. 12 is a SEM of the milled silicon of this invention.

FIG. 13 is a SEM of the milled silicon of this invention.

FIG. 14 is a Fourier transform infrared spectroscopy plot of milled silicon of this invention vacuum dried for 1 hour and 12 hours.

FIG. 15 is a Fourier transform infrared spectroscopy plot of milled silicon of this invention vacuum dried for 1 hour.

FIG. 16 is a SEM of a composite particle of this invention.

FIG. 17 is a SEM of a composite particle of this invention.

FIG. 18 is a plot of the capacity retention and coulombic efficiency of a half cell comprised of an anode comprised of the composite particles of this invention.

FIG. 19 is a plot of the capacity retention and coulombic efficiency of a half cell comprised of an anode comprised of the composite particles of this invention.

FIG. 20 is a plot of the capacity retention of a half cell comprised of an anode comprised of the composite particles of this invention.

FIG. 21 is a plot of the capacity retention of a half coin cell comprised of an anode comprised of the composite particles of this invention.

FIG. 22 is a plot of the capacity retention of a half coin cell comprised of an anode comprised of the composite particles of this invention.

FIG. 23 is a plot of the capacity retention of a half coin cell comprised of an anode comprised of the composite particles of this invention.

FIG. 24 are plots of the capacity retention of a full coin cells comprised of an anode comprised of the composite particles of this invention.

FIG. 25 is a SEM of an anode of this invention.

FIG. 26 is a SEM of an anode of this invention.

### DETAILED DESCRIPTION

In all instances if a particular method to determining a well-known characteristic of a material is not explicitly detailed, it is understood that any known standard or common method may be used to determine such material characteristic (e.g., capillary method for determining boiling point or boiling point range ISO4626:1980). The method of the invention is comprised of dispersing initial particles comprised of silicon in a solvent comprising a polar protic solvent, an aprotic polar solvent or combination thereof to form a slurry.

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3rd Edition, Cambridge University Press, Cambridge, 1987; the entire contents of each of which are incorporated herein by reference.

The terms “halo” and “halogen” as used herein refer to an atom selected from fluorine (fluoro, —F), chlorine (chloro, —Cl), bromine (bromo, —Br), and iodine (iodo, —I). The term “hydrocarbyl group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Aliphatic groups may contain 1-40 carbon atoms, 1-20 carbon atoms, 2-20 carbon atoms, 1-12 carbon atoms, 1-8 carbon atoms, 1-6 carbon atoms, 1-5 carbon atoms, 1-4 carbon atoms, 1-3 carbon atoms, or 1 or 2 carbon atoms. Exemplary aliphatic groups include, but are not limited to, linear or branched, alkyl and alkenyl groups, and hybrids thereof such as (cycloalkyl)alkyl, (cycloalkenyl)alkyl or (cycloalkyl)alkenyl. The aliphatic groups may be unsubstituted or substituted. Substituted means that one or more C or H atoms is replaced with oxygen, boron, sulfur, nitrogen, phosphorus or halogen. Typically, one to six carbon atoms may be independently replaced by the aforementioned and in particular oxygen, sulfur or nitrogen. The aliphatic group may have one or more “halo” and “halogen” atoms selected from fluorine (fluoro, —F), chlorine (chloro, —Cl), bromine (bromo, —Br), and iodine (iodo, —I).

The solvent may be any useful any protic or aprotic polar solvent that is suitable to for milling particulates. Typically, the solvent has a volatility that allows for the ease of removal in subsequent processing steps to form useful articles such as agglomerated secondary particles formed using suitable methods such as those known in the art (e.g., spray drying, freeze drying, vacuum drying or combination thereof). Typically, the solvent has a viscosity within an order of magnitude of the viscosity of water at ambient conditions (e.g., ˜ 1 centipoise @ about 20° C. to 25° C. and 1 atmosphere of pressure). That is the viscosity is typically less than 10 centipoise to 0.1 centipoise (cp). The volatility likewise as measured by the boiling point (or range) at 1 atmosphere of pressure is typically from about 30° C., 50° C. or 75° C. to 150° C., 200° C. or 250° C. The solvent typically has a molecular weight (weight average Mw) of Mw of at most about 500 g/moles, 200 g/moles, or even 150 g/moles to at least about 30 g/moles. It is understood, that in some instances, the solvent may be a solid at ambient conditions, but has the aforementioned boiling temperature and useful viscosity at an elevated temperature (e.g., less than about 100 cp or 10 cp), where the milling is carried out at an elevated temperature when milling.

The solvent may be a mixture of solvents. As an illustration the solvent may be mixture of a liquid solvent at room temperature and another solvent that is a solid at room temperature that dissolves in the liquid solvent, where the dissolved solvent imparts one or more desirable characteristic (e.g., improved stability of the dispersion after milling). The dissolved solvent may also be allowed to condense upon the particles after removal of the liquid solvent at conditions below the boiling point of the dissolved solvent. As an illustration, it has been discovered that a solution of solvents comprised of a nitrile solvent may be advantageous to mill the silicon particulates. Surprisingly, even when solvents other than a nitrile are present in the solution, the milled silicon powder displays the nitrile at the surface of the Si particulates even after vacuum drying whereas the other solvent used during milling is not seen in FTIR spectroscopy of the dried milled silicon powder. The silicon milled in the presence of a nitrile solvent and dried (e.g., vacuum of 1 to 30 Torr and temperature above the boiling point of the solvent with the highest boiling point to about 20° C. above the solvent with the highest boiling point) behaves as a dry powder that is flowable without further grinding, whereas in the absence of the nitrile solvent, the milled dried silicon powder even when gently removing the solvent (e.g., rotary evaporated) forms rigid hard masses that must be subsequently ground (e.g., mortar and pestled or equivalent). The amount of nitrile solvent may be any useful amount to realize this effect and surprisingly may be from 1%, 5%, 10% or 15% to 50%, 75%, 90% or essentially 100% of the solvent used to mill the silicon.

It has been discovered that the solvent may contain some water and still yield a milled silicon containing powder useful for making battery electrodes (i.e., the amount particles size and amount of oxygen desired is still obtainable) and particularly when the solvent is comprised of a nitrile solvent. Generally, the amount of water in the solvent is at most about 1%, 0.5%, 0.2%, 0.1%, 0.05%, 0.01% or 10 parts per million (ppm) by weight. The water concentration may be determined by any suitable method such as Karl Fischer titration. To realize the desired water concentration any suitable method for drying solvents may be employed such as those known in the art. For example, the solvents may be dried by distillation or contacted with molecular sieves to remove water. Dried solvents may be further denatured as described and specified by U.S. Title 27 of the Code of Federal Regulations Section 21.151. The desired water concentration may be realized by a known method such as described by U.S. Pat. No. 10,569,278.

The solvent has one or more groups creating a sufficient dipole to realize a dielectric constant of at least 10 and typically less than about 100. Examples of such groups include an, ether, carbonyl, ester, alcohol, amine, nitrile, amide, imide, halogen or any combination thereof. Desirably, the dielectric constant of the solvents is at least about 15 to about 90, 80 or 50, 40, 30 or 20. The dielectric constant may be calculated from the dipoles present in the solvent molecule or determined experimentally such as described in J. Phys. Chem. C 2017, 121, 2, 1025-1031. When the dielectric constant is above 10 and not too high, it has been found that the milled silicon particles may form a stable dispersion as described above in the absence of a surfactant, which may be deleterious for forming an electrode having desirable characteristics such as (cyclability).

The solvent may be linear, branched, aromatic or cyclic having the aforementioned Mw with one or more heteroatoms (e.g., O, N, S, Si or halogen) to about 10, 8, 6, 4 or 3 heteroatoms so long as the solvent has a dielectric constant of at least about 10. Typically, the amount of carbons is from 1 to 24, 18, 16, 12 or 6. Examples, of polar aprotic solvents that may be useful include, ketone (e.g., acetone, di-isopropyl ketone and methyl butyl ketone), aliphatic or aromatic halogenated hydrocarbon solvent (e.g., chloromethane, dichloromethane, trichloromethane, 1,2-dichloroethane, or 1,1,1-trichloroethane, chlorobenzene, 1,2-dichlorobenzene, 1,3-dichlorobenzene, and 1,2,3-trichlorobenzene), carbonate (e.g., propylene carbonate (PC), ethylene carbonate (EC), butylene carbonate (BC), chloroethylene carbonate, fluorocarbonate solvents (e.g., fluoroethylene carbonate and trifluoromethyl propylene carbonate), as well as the dialkylcarbonate solvents, such as dimethyl carbonate (DMC), diethyl carbonate (DEC), dipropyl carbonate (DPC), ethyl methyl carbonate (EMC), methyl propyl carbonate (MPC), and ethyl propyl carbonate (EPC).

Some examples of sulfone solvents include methyl sulfone, ethyl methyl sulfone, methyl phenyl sulfone, methyl isopropyl sulfone (MIPS), propyl sulfone, butyl sulfone, tetramethylene sulfone (sulfolane), phenyl vinyl sulfone, allyl methyl sulfone, methyl vinyl sulfone, divinyl sulfone (vinyl sulfone), diphenyl sulfone (phenyl sulfone), dibenzyl sulfone (benzyl sulfone), vinylene sulfone, butadiene sulfone, 4-methoxyphenyl methyl sulfone, 4-chlorophenyl methyl sulfone, 2-chlorophenyl methyl sulfone, 3,4-dichlorophenyl methyl sulfone, 4-(methylsulfonyl) toluene, 2-(methylsulfonyl) ethanol, 4-bromophenyl methyl sulfone, 2-bromophenyl methyl sulfone, 4-fluorophenyl methyl sulfone, 2-fluorophenyl methyl sulfone, 4-aminophenyl methyl sulfone, a sultone (e.g., 1,3-propanesultone), and (e.g., 2-methoxyethyl(methyl)sulfone and 2-sulfone solvents containing ether groups methoxyethoxyethyl(ethyl)sulfone).

The polar aprotic solvent may also be silicon-containing, e.g., a siloxane or silane. Some examples of siloxane solvents include hexamethyldisiloxane (HMDS), 1,3-divinyltetramethyldisiloxane, the polysiloxanes, and polysiloxane-polyoxyalkylene derivatives. Some examples of silane solvents include methoxytrimethylsilane, ethoxytrimethylsilane, dimethoxydimethylsilane, methyltrimethoxysilane, and 2-(ethoxy) ethoxytrimethylsilane.

Other examples of polar aprotic solvents include diethyl ether, 1,2-dimethoxyethane, 1,2-diethoxyethane, 1,3-dioxolane, tetrahydrofuran, 2-methyltetrahydrofuran, tetrahydropyran, diglyme, triglyme, 1,3-dioxolane, and the fluorinated ethers (e.g., mono-, di-, tri-, tetra-, penta-, hexa- and per-fluoro derivatives of any of the foregoing ethers and 1,4-butyrolactone, ethylacetate, methylpropionate, ethylpropionate, propylpropionate, methylbutyrate, ethylbutyrate, the formates (e.g., methyl formate, ethyl formate, or propyl formate), and the fluorinated esters (e.g., mono-, di-, tri-, tetra-, penta-, hexa- and per-fluoro derivatives of any of the foregoing esters). Some examples of nitrile solvents include acetonitrile, benzonitrile, propionitrile, and butyronitrile. Some examples of sulfoxide solvents include dimethyl sulfoxide, ethyl methyl sulfoxide, diethyl sulfoxide, methyl propyl sulfoxide, and ethyl propyl sulfoxide. Some examples of amide solvents include formamide, N,N-dimethylformamide, N,N-diethylformamide, acetamide, dimethylacetamide, diethylacetamide, gamma-butyrolactam, and N-methylpyrrolidone.

It has been discovered that nitriles during the milling are attached on the milled silicon surfaces formed during the milling with great tenacity and herein referred to as chemisorbed. Without being limiting in any way, the nitrile may form a ligand with the newly formed silicon surfaces even in the presence of other solvents (e.g., an alcohol such as isopropyl alcohol) present when milling including water contaminants. The nitrile solvent may be represented by R—C≡N, wherein R is hydrocarbyl group having from 1 to 36, 24, 18, 12 or 6 carbons. Hydrocarbyl as used herein refers to a group containing one or more carbon atom backbones and hydrogen atoms, which may optionally contain one or more heteroatoms. Heteroatom means nitrogen, oxygen, sulfur and phosphorus, more preferred heteroatoms include nitrogen and oxygen. Where the hydrocarbyl group contains heteroatoms, the heteroatoms may form one or more functional groups well known to one skilled in the art. Hydrocarbyl groups may contain cycloaliphatic, aliphatic, aromatic or any combination of such segments. The aliphatic segments can be straight or branched. The aliphatic and cycloaliphatic segments may include one or more double and/or triple bonds. Included in hydrocarbyl groups are alkyl, alkenyl, alkynyl, aryl, cycloalkyl, cycloalkenyl, alkaryl and aralkyl groups. Cycloaliphatic groups may contain both cyclic portions and noncyclic portions. R may be an unsubstituted hydrocarbyl group having from 1 to 36, 24, 18, 12 or 6 carbons, R may be a hydrocarbyl group comprised of an aromatic group having from 5 to 36, 24, 18, 12, or 6 carbons and desirably R is comprised of an unsubstituted aromatic group (e.g., benzene ring or fused benzene rings). When R is comprised of an aromatic ring, it may be further comprised of a hydroxyl group (e.g., cyanohydrin).

The polar aprotic solvent may also be diethyl ether, tetrahydrofuran, and dioxane), hexamethylphosphoramide (HMPA), N-methylpyrrolidinone (NMP), 1,3-dimethyl-3,4,5,6-tetrahydro-2 (1H)-pyrimidinone (DMPU), and propylene glycol monomethyl ether acetate (PGMEA).

The solvent may be a polar protic solvent. A polar protic solvent is one that contains a hydrogen atom attached to an electronegative atom, such that the hydrogen has a proton-like character and/or the bond between the hydrogen and electronegative atom is polarized. Exemplary polar protic solvents include, but are not limited to alcohols, carboxylic acids including monohydric, dihydric and trihydric alcohols. Exemplary alcohols include those having from 1 or 2 to 12 or 6 carbons such as phenol, methanol, ethanol, propanol (including of each of its isomers: 1-propanol, 2-propanol (isopropanol or IPA herein)), butanol (inclusive of each of its isomers: 1-butanol, 2-butanol, 2-methylpropan-1-ol and 2-methyl-2-propanol). It may be desirable to have a combination of two or more miscible solvents. One of the solvents may be a solid at ambient conditions that is dissolved in a liquid solvent at ambient conditions such as a phenol dissolved in an aliphatic alcohol such as IPA. The concentrations of multiple solvents may be any useful for milling the particles comprised of silicon.

The particulates comprised of silicon (also referred to herein as “silicon particulates or silicon powder) may be any suitable silicon useful for making a battery electrode and may be pure silicon (having at most trace amounts of contaminants other than oxygen from the oxidation of the silicon) or an alloy of silicon. For example, the silicon may be a p or n doped silicon or an alloy of silicon such as known in the art. The silicon alloy may be for example, those silicon alloys described by U.S. Pat. Publ. 2017/0338483. Typically, the alloy of silicon has at from any useful amount (10 ppm, 100 ppm, 1%, to 10%, 20% or 30% by weight) of the alloying element such as another Group 14 element (e.g., Ge or Sn), a transition metal or rare earth metal (e.g., aluminum, iron, titanium, chromium, copper, zirconium, titanium, vanadium, manganese, tungsten, niobium, and molybdenum). Any combination of silicon and silicon alloys may make up the initial silicon particulates.

The initial silicon particulates may be derived from an ingots forming the silicon or alloy thereof and may be also be waste silicon (e.g., waste silicon from the processing of silicon wafers). To realize a useful initial silicon particulate to make the that is reduced in size by known wet or dry milling methods to realize a powder that can then be milled to below ˜100 nm (nanometers). That is, a substantial amount of the milled silicon particulates are less than 100 nm as described herein. Typically, the initial silicon particulates have an average size (equivalent spherical diameter) or D50 (median particle size by volume) that is less than 100 μm (micrometers), 50 μm, 25 μm, or 10 μm to about 1 μm or 0.5 μm, generally, the D90 and D10.

The slurry comprised of the initial silicon particles and solvent may have any useful solids loading. Generally, for the most efficient milling and pumpability, the slurry should have as high a solids loading as possible without having too high a viscosity to avoid, for example, clogging of screens and insufficient agitation of the milling media. Typically, the solids loading of the slurry is at least about 2%, 3% or 4% to 50%, 40%, 35%, 20% or 15% by weight of the initial silicon particulates and solvent. It is understood that if other solid additives are added and milled with the silicon, the solids loading includes all of the solids present in the slurry with aforementioned solids loading ranges being applicable thereto.

Other additives may be added to the slurry and milled with the initial silicon particulates that may be useful to make an electrode in an electrical device. The additive may be a solid (solid at ambient conditions) that is soluble or insoluble in the solvent. Illustrative additives include, but are not limited to binders, surfactants, porogens, electroconductive materials (e.g., solid electrolytes, carbon and carbon forming materials). The carbon may be any useful carbon that are useful in forming electrodes in batteries and may be amorphous to crystalline (graphitic and any combination thereof). Examples of carbon forming materials include polymers resins and the like that may desirably be dissolved or added as particulates (solid or emulsions) that may be interspersed or adsorbed upon the milled silicon upon removal of the solvent from the milled silicon. Such carbon forming materials may then be pyrolyzed to for carbon when forming a desired electrode or electronic component. Examples of carbon forming compounds may include polymers or resins such as aromatic containing polymers, resins and compounds that form cross-linked thermoset polymers. Illustratively, the carbon forming material may be a polycarbonate, epoxy, polyimide, polyamide, phenol-formaldehyde resin (e.g., resole and novolac resins), polyacrylonitrile pitch, carbon pitch (distillation product of coal or oil/petroleum tar). Desirably, the carbon pitch is a petroleum pitch having a softening temperature of 200° C., 225° C., 240° C. to 300° C., 275° C., or 260° C. as measured by the method described in ASTM D3104-14a. Examples of pitches having high softening points and high carbon yield that may be useful are described in U.S. Pat. Nos. 4,927,620 and 7,220,348, each incorporated herein by reference. The phenolic resin desirably is a novolac phenolic resin dissolvable in alcohols such as those known in the art with representative examples being described in U.S. Pat. Nos. 3,244,671 and 3,299,167 and U.S. Pat. Pub. No. 2006/0241276.

When the additive is a solid and does not dissolve at the milling conditions, the solid typically has an average size or D50 size (median by volume) that is within an order of magnitude of the initial silicon particulate average size or D50. The amount of the additive may be any useful amount for making an electrode or electronic device from the milled silicon. Illustratively, the amount may be from as little as 0.1% to 90%. Typically, the amount may be from 1%, 2%, 5% or 10% to 75% to 50%, 30% or 25%. When a solid carbon is present, it desirably is present in a volumetric amount such that the volume of silicon particles/carbon particles is from 1/20 or 1/10 to 20 or 10.

The milling may be performed using any suitable method for agitating the milling media sufficiently to yield the desired milled particulates comprised of silicon (“milled silicon”). Illustrative milling methods include, for example, stirred milling, vibratory milling, ultrasonic induced milling, and planetary milling. Suitable milling may be performed in commercially available stirred mills such as those available from Buhler Group (Germany) and Netzsch GmbH (Germany); sonic mills available from Resodyn Corporation. (Butte, MT) and planetary mills available from Glen Mills Inc., (Clifton, NJ) and Retsch GmbH (Germany).

Desirably, the milling media occupies at least 50% by volume of the milling container, but generally, the milling media occupies greater than 75%, 80%, 90% to 95%, 99% or essentially the entire volume so long as the media may still be stirred or agitated. The volume occupied by the milling media is understood to be the bulk volume (i.e., the media and the interstitial porosity between the media).

When milling the initial silicon, the milling media is sufficiently larger than the initial silicon particulates to maximize the milling energy and milling interactions for the most efficient grinding to the desired nanometer scale of the silicon particulates. The milling media average size is at least about 5 to 200 times greater than the initial silicon average particulate size. Desirably, the milling media average size is at least 10 or 20 times to 150, 100 or 75 times larger than the average initial silicon particulate size. Generally, the smallest milling media present should be at least 2, 3 or 5 times the size of the largest initial silicon particulate size. Particles size if not specified otherwise, is the equivalent spherical diameter by volume and may be determined by known sieving, laser light scattering methods or micrographically depending on the size regime of the particulates or milling media. It is also desirable for the milling media to have a narrow size distribution as possible. Illustratively, the milling media the D90 or D100 and D1 or D0 are within 20% or 10% or 5% of the D50 size (by number or volume). Typically, the milling media has an average size or median size from about 1 mm, 500 μm, 300 μm, 250 μm or 150 μm to 25 μm, 30 μm or 50 μm by volume. The milling may be performed in a series of milling steps where larger initial silicon particles are milled with larger milling media and then subsequently be milled with progressively smaller media continuously with multiple mills connected in series or batch (changing the milling media in the same mill for example).

The milling media may be any useful shape such as spherical, ellipsoidal or cylindrical. Desirably, the milling media is spherical. To minimize contamination and efficient milling, the media should be substantially harder than the particulates comprised of silicon. Generally, the milling media has a Vickers hardness (ASTM E384 “micro testing”) is at least 5 GPa. Desirably, the milling media is a ceramic or ceramic metal composite (e.g., WC/Co). The milling media may be any useful ceramic for milling the silicon without causing deleterious contamination. The ceramic milling media may be comprised of silicon such as carbides, nitrides, oxides or combinations thereof of silicon. Desirably, the density of the milling media is greater than the silicon particulates and generally is at least about 2.5 g/cc, 3 g/cc, 4 g/cc to 10 g/cc. Examples of milling media include those comprised of zirconium such as cubic stabilized zirconia (e.g., stabilized with one or more of Mg, Ca, Y, Ce, Al and Hf), zircon, silicon carbide, WC/Co, mixed carbides such as those described in U.S. Pat. No. 5,563,107 and WO 2004/110699, incorporated herein by reference. Cubic stabilized zirconia milling media that are suitable may be obtained from Chemco Advanced Material (Suzhou) Co., Ltd., China.

The milling may be performed for any length of time suitable to form the milled silicon and may depend on the initial silicon particulate size and as required multiple milling steps as described previously. Typically, the amount of time is from about 1 hour to 48 hours and may be continuously applied or intermittent. The temperature may be any useful temperature and may, for example, depend on the particular solvent or solvents used (e.g., heating of a solvent to liquefy it and achieve a desired viscosity of the slurry). The heating or cooling may be accomplished by know methods of cooling such as water jackets and heating tapes on the exterior of the mill.

Surprisingly, the milling of the silicon particulates in the solvent to form the milled silicon particles may form a stable dispersion of milled silicon particles typically having a D90 or D100 of less than 300 nm, 250 nm or 200 nm or 150 nm and a D0 or 10 greater than 5 nm, 10 nm, 20 nm, 30 nm, 40 nm or 50 nm with a D50 being with the aforementioned range and generally from about 150 nm or 125 nm to about 50 nm, 60 nm, 70 nm or 80 nm. Stable dispersion herein means that the slurry having the solids loading described herein fails to settle by eye under gravity for 24 hours, 48 hours, 5 days or 10 days even in the absence of a surfactant. Surfactant is a compound as commonly understood in the art lowers the surface tension between a liquid-liquid or solid-liquid interface and is comprised of lyophobic or lyophilic ends that orient to lower the interfacial surface tension at the particular interface. The surfactant may be anionic, cationic, nonionic or amphoteric.

It is unclear why the present method realizes the stable dispersion of the milled silicon particles, and without being limiting in any way may be due to differing surface chemistries that are formed by the solvents when milling the silicon particles and subsequent interaction with the solvent (e.g., the protic and aprotic solvents). Likewise, it has been discovered that stable dispersion may be formed with both carbon particulates and silicon particles when milled together as previously described in the absence of a surfactant, which may be particularly useful when forming secondary particles realized by removing the solvent in processes to form electrodes (e.g., absence of deleterious residues when forming an electrode arising from the decomposition of the surfactant). The stable dispersions may have other additives as described above that are milled, but these may also be added post milling while merely stirring if desirable (e.g., carbon forming pitches).

Surprisingly, the initial silicon even though milled for the same amount of power input or time with the same conditions realizes a milled silicon having smaller particle size and higher surface area while having an oxygen concentration that is essentially the same when not using the solvent of this invention. That is the total oxygen concentration of the milled silicon has a lower ratio of oxygen (wt %)/specific surface area (m²/g). The total oxygen concentration may be performed by fully oxidizing the milled silicon in a TGA (thermogravimetric analyzer) and calculating the oxygen of milled silicon deviation from pure silicon. Surface area may be determined by the well-known BET (Brunauer-Emmett-Teller) nitrogen adsorption method (e.g., ISO 9277:2010).

The milled silicon desirably has the aforementioned particle size and distribution and a specific surface area of 30 m²/g, 40 m²/g, m²/g, 60 m²/g, 70 m²/g to about 200 m²/g, 175 m²/g, or 150 m²/g. The milled silicon surprisingly has a low ratio oxygen content/specific surface area (wt %/m²/g) even when the surface area is higher than silicon milled in non-polar solvents such as hydrocarbons. Desirably, the ratio is at most about 0.250, 0.225, 0.200, 0.195, 0.190, or 0.180 to 0.100, 0.125, 0.150 or 0.160 when the surface area is at least 30, 40 or 55 m²/g to 200 m²/g. These oxygen concentrations surprisingly may be realized in the absence of any etching or post-milling removal of oxygen. The milled silicon particles also display differing surface oxidation from silicon milled in hydrocarbons, where the silicon oxide that is present is present as SiO₂ and SiOₓ where x is less than 2 (It is understood that x may range from less than 2 to any reasonable amount greater than 0 and is determined by deconvolution of XPS spectra of the surface of the milled silicon particles as described herein). The surface chemistry of the milled silicon may have a ratio of SiOₓ/SiO₂ that is less than 3.5, 3.4, 3.3 or 3.2 to at most about 1, 2 or 2.5 as determined by the deconvolution of the Si binding peak areas in the vicinity of about 105 eV to 92 eV.

The milled silicon may be useful for making electrode using suitable techniques such as those known in the art. Illustratively, the components of the electrode may be added to the milled silicon slurry and the solvent removed to produce secondary particles comprised of the milled silicon. The solvent may be removed by any suitable technique such as those known in the art (e.g., spray drying and freeze drying). The secondary particles may then be shaped into electrodes by methods common in the art (e.g., casting or pressing onto a metal foil). The electrodes may be used in an electrical device such as a battery.

It has been discovered that improved secondary particles and pyrolyzed composite particles formed therefrom may be formed by dissolving two or more carbon forming materials having differing solubilities in the solvents of the solution and one of the carbon forming materials when pyrolyzed forms carbon with characteristics different than another of the carbon forming materials. Illustratively, the carbon forming materials may be a carbon forming material that forms a soft carbon “soft carbon forming material” (graphitic carbon with an example being petroleum pitch) and a carbon forming material that forms hard carbon “hard carbon forming material” (non-graphitized even when pyrolyzed to temperatures of 3000° C., with an example being phenolic resins). As an illustration, the solvent may be comprised of an aromatic nitrile and an alcohol with the carbon forming materials being comprised of a phenolic resin and a petroleum pitch. In such an illustration, the phenolic resin is preferentially dissolved in the alcohol and the petroleum pitch is preferentially dissolved in the aromatic nitrile. Secondary particles of silicon and the carbon forming materials dissolved lead to pyrolyzed composite Si—C particles displaying improved cycle lives, which, without being limiting, may be due to more uniform coating and/or distribution of the carbon forming materials rendering a more uniform carbon matrix upon pyrolysis.

When forming the secondary particles, the amount of the hard carbon forming material and soft carbon forming material may be any useful weight ratio such as from 1/10 to 10/1 with it generally being desirable for the amount soft carbon forming material (graphitizable) is the majority of the carbon forming material by weight (soft carbon/hard carbon of at least 1/1 to 20/1, 10/1, 5/1 or 3/1), The amount of the solvent that preferentially dissolves the soft carbon forming material needs to be sufficiently present to ensure uniform coating and distribution in the secondary particle. Illustratively, such a solvent is comprised of an aromatic constituent such as an aromatic nitrile (e.g., benzonitrile) in sufficient quantity to adequately dissolve the soft carbon forming material (e.g., petroleum pitch) along with the hard carbon forming material. Generally, the solvent comprises at least 5%, 10% or 15% to 90%, 75% or 50% of an aromatic solvent (e.g., aromatic nitrile such as benzonitrile) with the balance being a solvent that dissolves the hard carbon forming material (e.g., phenolic resin) such as a polar protic solvent (e.g. an alcohol such as isopropyl alcohol).

In an illustration, the solvent used to mill the silicon (milling solvent) may be used when forming the secondary particle or the solvent may be varied. For example, the milling solvent may varied by preferentially removing a low boiling solvent (e.g., polar protic solvent “alcohol” such as isopropyl alcohol) from a solution of a high boiling solvent such as an aromatic polar aprotic solvent (e.g., aromatic nitrile) and a low boiling solvent such as a polar protic solvent (e.g., isopropyl alcohol). The solvent of the slurry may be altered by addition of a further solvent to the milled slurry to realize the desired dissolution of one or more carbon forming materials and ease of spray drying (eg., addition of an aromatic nitrile while optionally removing a low boiling point solvent such as an alcohol). The solvent used to form the secondary particle, for example, by spray drying (spray drying solvent) may involve preferentially removing a solvent and adding a different solvent. Alternatively, the milling solvent may be removed by any useful method (e.g., filtration or vacuum drying) and the milled silicon particles redispersed in a desired spray drying solvent. Illustratively, a portion of the low boiling point solvent (e.g., alcohol) may be removed increasing the concentration of the high boiling point (e.g., aromatic nitrile) solvent with further additions of other solvents such as a nitrile solvent to for the spray drying solvent.

Illustratively, the milling and spray drying solvent may have the same concentration of the nitrile solvent or it may be different. It may be desirable, for example, for the milling solvent to have a lower concentration of a nitrile solvent (particularly if it is a high boiling point solvent (having a boiling point greater than water) such as an aromatic nitrile solvent when milling and then having a spray drying solvent with a higher concentration of the high boiling point nitrile solvent. For example, the concentration of the nitrile solvent in the spray drying solvent may be 1.5, 2, 3 or 5 times greater than its concentration in the milling solvent to essentially 100%, but, preferably, at most 90% of the spray drying solvent is the nitrile solvent. Desirably, the solvent is comprised of the high boiling point nitrile solvent and an aprotic polar solvent having a low boiling point. The difference in the boiling points of the aprotic polar solvent and nitrile solvent is desirably at least 10° C., 20° C., or 50° C. to 200° C. or 150° C.

The milled silicon powder slurry comprised of spray drying solvent (spray drying slurry) may be atomized by any suitable method and apparatus and the solvent removed by any suitable method such as one known in the art (e.g., spray drying). In an illustration, the secondary particles are comprised of the milled silicon in a resinous matrix of carbon forming materials comprised of a soft carbon forming material and a hard carbon forming material. The resinous matrix is typically a continuous matrix having the silicon particles embedded therein. The resinous matrix may have other constituents such as additives described above that may be added during milling or when forming the spray drying slurry such as solid particulate carbon. The secondary particles desirably have a particle size wherein the secondary particle has a D90 particle size of at most 20 or 15 micrometers, a D10 of at least 0.5 or 1 micrometers and a D50 of 2 or 3 to 10 or 7 micrometers. The particle size may be determined by any suitable method such as those known in the art including, for example, laser diffraction or image analysis of micrographs of a sufficient number of particles (˜100 to ˜200 particles). A representative laser diffractometer is one produced by Microtrac such as the Microtrac S3500.

Desirably, the secondary particles may be formed by spray drying a spray drying slurry comprised of silicon having a surface area of 30 m²/g to 200 m²/g and a soft carbon forming material and hard carbon forming material at a weight ratio of soft carbon forming material/hard carbon ratio of 20/1 to 1/10 dissolved in a spray drying solvent comprised of a nitrile solvent. The weight ratio of the soft carbon forming material/hard carbon forming material desirably being from 10/1 to 1/1, 2/1 or 3/1. The nitrile solvent may be one as described herein. The silicon may be any milled silicon described including a silicon having a chemisorbed nitrile.

The secondary particles may then be made into silicon-carbon composite particles (composite powder), by pyrolyzing the secondary particles at a temperature and time in a non-oxidizing atmosphere sufficient to form the composite particles. The temperature may be any useful temperature below where the soft carbon forming material graphitizes and typically the temperature is at most about 2000° C., 1500° C., or 1200° C. to at least about 500° C., 600° C., 700° C. or 800° C. The time at the maximum temperature when pyrolyzing may any useful and typically is from 1 minute, 5 minutes, 10 minutes, 20 minutes or 30 minutes to any practical time including for example 24 hours, 12 hours, 6 hours, 2 hours or 90 minutes. The pyrolyzing may have more than one hold temperature during the pyrolyzing, for example, to cure the resinous matrix before carbonizing it (e.g., 100° C., 125° C. to 250° C. or 200° C.). Likewise, the heating rate may be any useful heating and cooling rate to realize the desired particle characteristics with 1° C./min, 5° C./min, or 10° C. to 200° C./min, 150° C./min or 100° C./min. The heating rate may varied depending on the temperature and any reactions that may occur or evolution of gasses arising from the decomposition of the resinous matrix when forming carbon. The particle size and morphology of the composite powder is generally the same as for the secondary particles except that the specific surface area increases due to the formation of the carbon from the resinous matrix. Desirably, the specific surface area (BET nitrogen adsorption) of the composite powder is from 2 m²/g, 3 m²/g, 4 m²/g to 10 m²/g, 8 m²/g or 7 m²/g.

The amount of silicon present in the composite powder may be any useful and may range over a wide range such as 10% to 75% by weight silicon with the balance being carbon. Desirably, the amount of carbon is at least 30%, 40% or 45% to 70% or 60% by weight of the composite powder. The soft carbon and hard carbon present may be any useful and generally it is desirable for the soft carbon to be present in an amount of at least 25%, 30%, 40%, 45%, 50% to 90%, 85%, 80%, 75%, 70%, 65% or 60% by weight of the composite powder. Desirably, the composite powder is formed from silicon particulates having chemisorbed nitrile (e.g., arising from the chemisorption of the nitrile during milling) resulting in a nitrile functionality as determined by XPS as described in the Examples. In particular, the intensity of the disordered carbon peak (I_{d}) over the intensity of the graphitized carbon peak (I_{g}) is at most about 1. It is believed, without being limiting in any way, that the presence of the chemisorbed nitrile may facilitate the coating of the silicon with the soft carbon forming material resulting in longer cycle life even at higher silicon loading (greater than about 25% by weight of the composite powder). The presence of such nitrile functionality in the composite powder when used in an electrode realizes longer cycle life compared to similarly prepared batteries in the absence of the nitrile when milling. Desirably, the nitrile solvent is present during milling and present in the spray drying solvent. It is also desirable that the milling solvent is not removed but adjusted to a higher concentration of nitrile solvent in the spray drying solvent.

The composite powder may be made into an electrode (e.g., anode) for use in a battery. A useful anode is comprised of a composite powder having a D50 of 2 to 8 micrometers and being comprised of at least 30% soft carbon and 30% to 75% by weight silicon powder having a surface area of 30 m²/g to 200 m²/g, and a spherical graphite having a D50 from 1.5 to 4 times greater than the D50 of the composite powder and a polymeric binder. Desirably, the composite powder has nitrile functionality as determined by XPS. The composite powder may be any of those described herein.

The spherical graphite may be any suitable for use in a battery such as those known in the art. The spherical graphite, typically, has a D90, D50 and D10 size that are independently from 1.5 to 4, 3, or 2.5 times the corresponding D90, D50 and D10 of the composite powder. It is understood that the spherical graphite is not perfectly spherical but may be ovoid in nature and are not flakes. The spherical graphite, generally, has a high purity such as at least 99.95% pure, but may also be comprised of a small amount of oxides such as silica, titania and zirconia (e.g., less than 5% or 1% by volume). The spherical graphite may be from artificial graphite or purified natural graphite. Examples of useful spherical graphites are described in U.S. Pat. Pub. US20160141603A1, incorporated herein by reference. Examples of suitable commercially available spherical graphites include those available from Syrah Resources, Magnis Resources, Northern Graphite, Focus Graphite and Graphite One. The amount of spherical graphite/composite powder by weight may be any useful ratio for making an anode, but typically the amount of the spherical graphite/composite powder is from 0.1, 0.2, 0.5 to 20, 10, 5 or 2.

The polymer may be any suitable such as those known in the art useful as a binder and may include, for example, carboxy methyl cellulose (CMC), styrene-butadiene rubber (SBR), polyvinylidene fluoride (PVDF), poly-tetrafluoroethylene (PTFE), or a mixture of two or more thereof. Desirably, the anode is comprised of PVDF. The anode may have a further additive including those previously described herein such as graphite, carbon black, carbon nanotubes, graphene and carbon fiber. The amount of polymer may be any suitable amount, but generally is at most about 20% or 10% by volume to about 0.1%, 0.5% or 1% by volume of the anode.

When making the anode, the spherical graphite, composite powder and polymer are mixed in a solvent that dissolves the polymer (e.g., PVDF dissolved in NMP). The slurry that is formed may have any solids loading (such as described for milling herein). The shear rate is such that neither the spherical graphite nor the composite powder are attrited. That is the shear rate is such that the ratio of the composite powder D50/spherical graphite D50 is within 20%, 10% or 5% of the said ratio prior to mixing and forming of the anode on a current collector. Low shear axial impeller mixing being an example of sufficient mixing shear (e.g., 1 to 50 s⁻¹). The slurry may then be cast and dried on a current collector (e.g., copper foil) to form the anode and pressed if desired so long as the pressure fails to deform the composite powder and the spherical graphite. That is the anode retains the particle size and morphology of composite powder and spherical graphite prior to be mixed, cast, and pressed to form the anode, which may be determinable by electron microscopy.

### ILLUSTRATIVE EMBODIMENTS

Embodiment 1. A method to form particles comprising:
(i) dispersing initial particles comprised of silicon in a solvent comprising a polar protic solvent, an aprotic polar solvent or combination thereof to form a slurry, and
(ii) milling the initial particles comprised of silicon in the slurry with milling media to formed milled particles comprised of silicon, wherein the initial particles and the milling media each have an average particle size and the average size of the milling media to average size of the initial particles is at least about 5 to about 200.

Embodiment 2. The method of embodiment 1, wherein the solvent is comprised of oxygen.

Embodiment 3. The method of either embodiment 1 or 2, wherein the solvent has a dielectric constant of at least about 10 to about 100

Embodiment 4. The method of any one of the preceding embodiments, wherein the solvent is comprised of the polar protic solvent.

Embodiment 5. The method any one of the preceding embodiments, wherein the polar protic solvent is an alcohol.

Embodiment 6. The method of embodiment 5, wherein the alcohol has from 1 to 12 carbons.

Embodiment 7. The method of embodiment 6, wherein the alcohol has from 2 to 6 carbons.

Embodiment 8. The method of embodiment 7, wherein the alcohol is 1 propanol, 2-propanol, 1-butanol, 2-butanol, 2-methylpropan-1-ol, 2-methylpropanol or combination thereof.

Embodiment 9. The method of any one of the preceding embodiments, wherein the solvent is comprised of at least two solvents.

Embodiment 10. The method of any one of embodiments 1 to 3, wherein the solvent is comprised of the aprotic polar solvent.

Embodiment 11. The method of embodiment 10, wherein the aprotic polar solvent is comprised of a cyclic group.

Embodiment 12. The method of embodiment 10, wherein the aprotic polar solvent is comprised of an aromatic group.

Embodiment 13. The method of any one of the preceding embodiments, wherein the solvent has water dissolved therein.

Embodiment 14. The method of embodiment 13, wherein the water is present in an amount from about 1 parts per million to about 30% by weight of the solvent and water.

Embodiment 15. The method of embodiment 14, wherein the amount of water is from 100 ppm to 10%.

Embodiment 16. The method of embodiment 15, wherein the amount of water is from 500 ppm to 2%.

Embodiment 17. The method of any one of the preceding embodiments wherein the milling media is a ceramic.

Embodiment 18. The method of embodiment 17, wherein milling media has a density of at least about 2.5 g/cc.

Embodiment 19. The method of either embodiment 17 or 18, wherein the milling media is comprised of an oxide, carbide, nitride or combination thereof.

Embodiment 20. The method any one of embodiments 17 to 19, wherein the milling media is comprised of an oxide.

Embodiment 21. The method of embodiment 20, wherein the milling media is comprised of silicon.

Embodiment 22. The method of any one of embodiments 17 to 21, wherein the milling media has a Vickers hardness of at least about 5 GPa.

Embodiment 23. The method of any one of embodiments 17 to 20 and 22, wherein the milling media is comprised of zirconium.

Embodiment 24. The method of embodiment 23, wherein the media is comprised of stabilized zirconia.

Embodiment 25. The method of any one of the preceding embodiments wherein the milling media is spherical.

Embodiment 26. The method of any one of the preceding embodiments wherein the milling media has an average size of 25 micrometers to 300 micrometers equivalent spherical diameter.

Embodiment 27. The method of embodiment 26, wherein the size of the milling media is 50 to 150 micrometers.

Embodiment 28. The method of either embodiment 26 or 27, wherein the milling media has a median size (D50) a D₁₀ and D₉₀ such that the D10 and D90 are within 5% of the median size.

Embodiment 29. The method of any one of the preceding embodiments wherein the initial particles of silicon have a solids loading of 5% to 50% by volume of the solvent and initial particles.

Embodiment 30. The method of embodiment 29, wherein the solids loading is from about 10% to 35%.

Embodiment 31. The method of any one of the preceding embodiments wherein the slurry is further comprised of an additive.

Embodiment 32. The method of embodiment 31, wherein the additive is comprised of at least one of the following: a surfactant, carbon forming compound, porogen, and carbon.

Embodiment 33. The method of embodiment 32, wherein the additive is particulate carbon.

Embodiment 34. The method of embodiment 33, wherein the particulate carbon is present in an amount of 10% to 90% by volume of the initial particles comprised of silicon and particulate carbon.

Embodiment 35. The method of any one of embodiments 32 to 34, wherein the additive is carbon and at least a portion of said carbon is graphitic.

Embodiment 36. The method of any one of the preceding embodiments wherein the initial particles comprised of silicon are silicon, alloy of silicon or combination thereof.

Embodiment 37. The method of embodiment 36, wherein the alloy of silicon is comprised of at least 50% by weight of silicon and at least one of the following elements: aluminum, iron, titanium, chromium, copper, zirconium, titanium, vanadium, manganese, tungsten, niobium, and molybdenum.

Embodiment 38. The method of any one of the preceding embodiments wherein the milled silicon particles have a specific surface area of at least 60 m²/g.

Embodiment 39. The method of embodiment 38, wherein the surface area is at least about 70 m²/g.

Embodiment 40. The method of any one of the preceding embodiments, wherein the milled silicon has an amount of amount of oxygen and a surface area wherein the amount of oxygen by weight percent to surface area by m²/g is at most 0.190 to about 0.125.

Embodiment 41. The method any one of the preceding embodiments wherein the milled silicon particles have a D10 of 5 nanometers (nm) to 50 nm, D50 of 50 nm to 150 nm and D90 of 300 nm to 100 nm.

Embodiment 42. The method of any one of the preceding embodiments wherein the milled silicon particles form a stable dispersion of milled silicon in the solvent.

Embodiment 43. The method of embodiment 42, wherein the stable dispersion is further comprised of an additive.

Embodiment 44. The method of embodiment 42, wherein the additive is carbon or carbon forming compound.

Embodiment 45. The method of any of embodiments 42 to 44, wherein the stable dispersion is in the absence of a surfactant.

Embodiment 46. The method of any one of the preceding embodiments, wherein the polar aprotic solvent is a nitrile solvent.

Embodiment 47. The method of embodiment 46, wherein the nitrile solvent is represented by:

R—C≡N

where R is hydrocarbyl group having from 1 to 36, 24, 18, 12 or 6 carbons.

Embodiment 48. The method of embodiment 47, wherein R is comprised of an aromatic group having 6 to 24 carbons.

Embodiment 49. The method of embodiment 48, R is unsubstituted.

Embodiment 50. The method of embodiment 49, wherein R is a phenyl group.

Embodiment 51. The method of any one of embodiments 46 to 50, wherein the solvent is comprised of the nitrile solvent having a boiling point and the polar protic solvent having a boiling point, the boiling point of the nitrile solvent being greater than the nitrile solvent.

Embodiment 52. The method of embodiment 51, wherein the boiling point of the nitrile solvent is at least 10° C. to 200° C. greater than the boiling point of the polar aprotic solvent.

Embodiment 53. The method of embodiment 52, wherein the boiling point of the nitrile solvent is at least 50° C. greater than the boiling point of the polar aprotic solvent.

Embodiment 54. The method embodiment 53, wherein the polar protic solvent is an alcohol.

Embodiment 55. A composition comprising a stable dispersion comprised of particulates comprised of silicon dispersed in a solvent comprised of a polar protic solvent, polar a protic solvent or combination thereof.

Embodiment 56. The composition of embodiment 55, wherein the stable dispersion is in the absence of a surfactant.

Embodiment 57. The composition of either embodiment 55 or 56, wherein the particulates of comprised of silicon have a solid loading of 2% to 50% by volume of the solvent and said particulates.

Embodiment 58. The composition of any one of embodiments 55 to 57 further comprised of another solid particulate comprised of carbon.

Embodiment 59. The composition of embodiment 58, wherein the particulates comprised of silicon and particulates comprised of carbon are present in a volumetric ratio of 1/20 to 20/1.

Embodiment 60. The composition of embodiment 59, wherein the volumetric ratio is 1/10 to 10/1.

Embodiment 61. The composition of any one of embodiments 55 to 60, wherein the stable dispersion is further comprised of a carbon forming compound.

Embodiment 62. The composition of any one of embodiments 55 to 61, wherein the composition is further comprised of particles comprised of carbon.

Embodiment 63. The composition of embodiment 62, wherein the particles comprised of carbon have an average particles size and the particles of silicon have an average particle size and the average size of the particles comprised of silicon and the average size of the particles of carbon have a size ratio that is from 10 to 0.1.

64. The composition of any one of embodiment 55 to 63, wherein the solvent is comprised of an aprotic polar solvent comprised of a nitrile.

Embodiment 65. The composition of embodiment 64, wherein the solvent is comprised of a polar protic solvent.

Embodiment 66. The composition of embodiment 65, wherein the polar protic solvent is an alcohol.

Embodiment 67. A composition comprising particulates comprised of silicon having a specific surface area of 30 m²/g to 200 m²/g and a chemisorbed nitrile.

Embodiment 68. The composition of embodiment 67, wherein the particulates comprised of silicon have an amount of oxygen from 2% to 10% by weight.

Embodiment 69. A composition comprising particulates comprised of silicon having a specific surface area of at least 30 m²/g to 200 m²/g, wherein an amount of oxygen by weight percent to surface area by m²/g is at most 0.300 to about 0.100.

Embodiment 70. The composition of embodiment 55, wherein the particulates comprised of silicon have an amount of oxygen and a surface area wherein the amount of oxygen by weight percent to surface area by m²/g is at most 0.250 to about 0.125.

Embodiment 71. The composition of embodiment 54, wherein the oxygen is present as SiO₂ and SiOₓ where x is less than 2 and the ratio of SiOₓ/SiO₂ by weight is at least about 3.3 as determined by X-ray photoelectron spectroscopy.

Embodiment 72. The composition of embodiment 57, wherein SiOₓ/SiO₂ is at least 3.5.

Embodiment 73. The composition of any one of embodiments 55 to 67, wherein the particulates of silicon have a chemisorbed nitrile.

Embodiment 74. The composition of embodiment 73, wherein the chemisorbed nitrile is represented by:

R—C≡N

where R is hydrocarbyl group having from 1 to 36 carbons.

Embodiment 75. The composition of embodiment 74, wherein R is comprised of a phenyl group.

Embodiment 76. A secondary particle comprised of particulates comprised of silicon having a specific surface area of at least 30 m²/g to 200 m²/g distributed within a resinous matrix comprised of a soft carbon forming material and a hard carbon forming material at a weight ratio of the soft carbon forming material/hard carbon forming material of 10/1 to 1/10.

Embodiment 77. The secondary particle of embodiment 76, wherein the particulates of silicon have an amount of oxygen by weight percent to surface area by m²/g is at most 0.300 to about 0.100

Embodiment 78. The secondary particle of either embodiment 76 or 77, wherein the particulates comprised of silicon have a chemisorbed nitrile.

Embodiment 79. The secondary particle of embodiment 78, wherein the chemisorbed nitrile is a nitrile represented by:

R—C≡N

where R is hydrocarbyl group having from 1 to 36 carbons.

Embodiment 80. The secondary particle of embodiment 79, wherein the chemisorbed nitrile is an aromatic nitrile and R has from 6 to 36 carbons.

Embodiment 81. The secondary particle of embodiment 80, wherein the chemisorbed nitrile is comprised of benzonitrile.

Embodiment 82. The secondary particle of any one of embodiments 76 to 81, wherein the weight ratio of the soft carbon forming material/hard carbon forming material is from 5/1 to 1/3.

Embodiment 83. The secondary particle of any one of embodiment 76 to 82, wherein the soft carbon forming material is comprised of a petroleum pitch and the hard carbon forming material is comprised of a phenolic resin.

Embodiment 84. The secondary particle of any one of embodiments 76 to 83, wherein the secondary particle has a D90 particle size of at most 20 micrometers, a D10 of at least 1 micrometer and a D50 of 5 to 10 micrometers.

Embodiment 85. A method of forming a secondary particle comprising,
(i) mixing particulates comprised of silicon and a carbon forming material dissolved in a spray drying solvent comprise of a nitrile to form a spray drying slurry,
(ii) atomizing the spray drying slurry and removing the spray drying slurry to form the secondary particles.

Embodiment 87. The method of embodiment 86, wherein the particulates comprised of silicon have a chemisorbed nitrile.

Embodiment 88. The method of either embodiment 86 or 87, wherein the carbon forming material is comprised of a soft carbon forming material and a hard carbon forming material.

Embodiment 89. The method of embodiment 88, wherein the soft carbon forming material is comprised of petroleum pitch.

Embodiment 90. The method of embodiment 89, wherein the petroleum pitch has a softening temperature from 225° C. to 275° C.

Embodiment 91 The method of any one of embodiments 87-89, wherein the soft carbon forming material/hard carbon forming material is a ratio of 5/1 to 1/3.

Embodiment 92. A secondary particle comprised of particulates comprised of silicon embedded in a carbon forming material, the particulates comprised of silicon having a surface area of 30 m²/g to 200 m²/g and an amount of oxygen by weight percent to surface area by m²/g from 0.300 to about 0.100.

Embodiment 93. The secondary particle of embodiment 92, wherein the particulates of silicon are comprised of a chemisorbed nitrile.

Embodiment 94. The secondary particle of embodiment 92 or 93, wherein the carbon forming material is comprised of a soft carbon forming material and a hard carbon forming material.

Embodiment 95. The secondary particle of embodiment 94, wherein the soft carbon forming material is comprised of a petroleum pitch.

Embodiment 96. The secondary particle of embodiment 95, wherein the petroleum pitch has a softening temperature from 225° C. to 275° C.

Embodiment 97. The secondary particle of any one of embodiments 87-89, wherein the soft carbon forming material/hard carbon forming material is a weight ratio of 5/1 to 1/3.

Embodiment 98. The secondary particle of any one embodiments 94 to 96, wherein the hard carbon forming material is a phenolic resin.

Embodiment 99. The secondary particle of any one of embodiments 92 to 98, wherein secondary particle has a D90 particle size of at most 20 micrometers, a D10 of at least 1 micrometer and a D50 of 5 to 10 micrometers

Embodiment 100. A method of forming a silicon-carbon composite particle comprising heating the secondary particle of any one of embodiments 91 to 98 to a pyrolysis temperature that carbonizes the carbon forming material to form the silicon-carbon composite particle.

Embodiment 101. The method of embodiment 100, wherein the pyrolysis temperature of 800° C. to 1500° C.

Embodiment 102. A composite particle comprised of particulates comprised of silicon having a nitrile residue and a surface area of 30 m²/g to 200 m²/g embedded in a carbon matrix comprised of soft carbon and hard carbon.

Embodiment 103. The composite particle of embodiment 102, wherein the soft carbon and hard carbon are present in a weight ratio of 5/1 to 3/1.

Embodiment 104. The composite particle of any one of embodiments 100 to 103, wherein the composite particle has a specific surface area of at 1 m²/g to 10 m²/g.

Embodiment 105. An anode comprised of the composite particle made by the method of either embodiment 100 or 101.

Embodiment 106. An anode comprised of the composite particle of any one of embodiments 102 to 104.

Embodiment 107. The anode of either embodiment 105 or 106, wherein the anode is further comprised of a polymer binder and a spherical graphite.

Embodiment 108. The anode of embodiment 107, wherein the composite particle has a D₉₀ particle size of at most 20 micrometers, a D₁₀ of at least 1 micrometer and a D₅₀ of 5 to 10 micrometers and the spherical graphite has a D₅₀ that is at least 1.5 to 4 times greater than the D₅₀ of the composite particle.

Embodiment 109. The anode of embodiment 107 or 108, wherein the composite particles and spherical graphite are present in a weight ratio of composite particles/spherical particles of 3/1 to 1/3.

Embodiment 110. A battery comprised of the anode of any one of embodiments 105 to 108.

### EXAMPLES

The following examples are provided to illustrate the invention, but are not intended to limit the scope. All parts and percentages are by weight unless otherwise indicated.

### Example 1

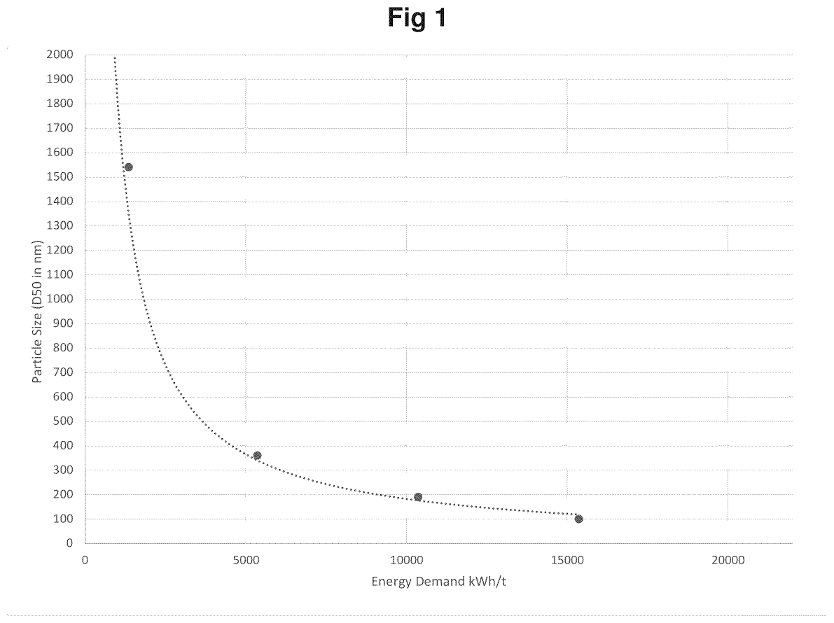

Silicon is dry milled and sieved to less than 60 micrometers to form an initial silicon having an average particles size 6-54 micrometer with no particles greater than 60 micrometers. The initial silicon is added to isopropanol (IPA) having a water concentration of about 1500 ppm by weight to form a slurry having ˜30% by weight silicon solids. The slurry is milled using a Buhler MMX1 (Switzerland) where the milling chamber is filled with 100 micrometer yittria stabilized zirconia milling media available from Buhler (Switzerland). The milling chamber is filled to about 85% by the milling media. The mill is typically run at 1600 RPM (revolutions per minute) and the speed is maintained at above 14 meters/second. The energy input tracked, and periodic sampling of the milled silicon is performed. The particle size D50 at differing energy inputs is determined and is shown in FIG. 1. Table 1 shows the results after ˜16000 kWh/MT (kilowatt-hours/metric ton) of milling input energy. Aliquot samples were dried at room temperature for particle size analysis.

The particle size is determined by scanning electron microscopy. The surface area is determined by BET nitrogen adsorption. The total oxygen content is determined by TGA as described herein.

### Comparative Examples 1-4

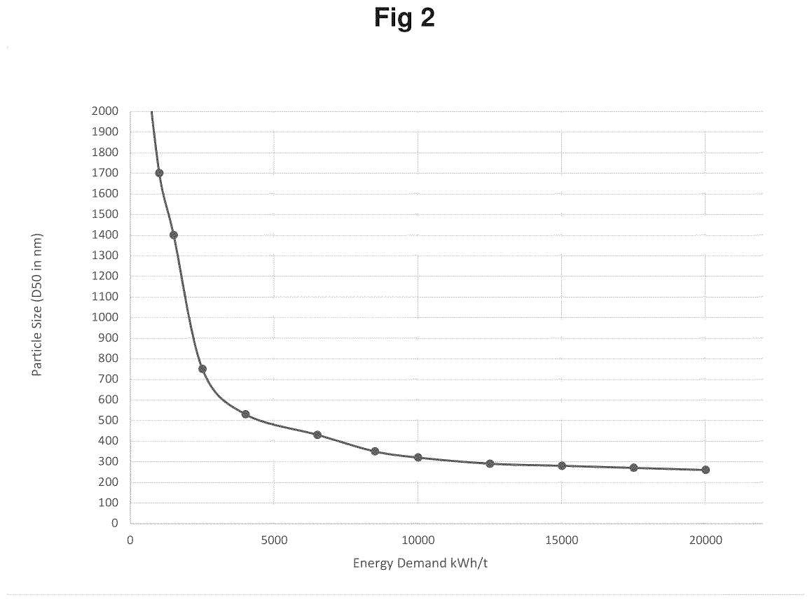

Example 1 is repeated except that IPA is replaced with the solvent as shown in Table 1, and slurry has a weight of ˜13% by weight silicon solids. FIG. 2 shows the progression of particle size reduction when milling in Hexane (Comparative Example 2). From the results each of the comparative examples milled in a non-polar aprotic solvent approach an asymptote where further energy input fails to reduce the particle size (D50) further and is substantially larger than realized in Example 1 using a polar protic solvent. Table 1 also shows the characteristics of these comparative examples after milling input energy of about 20000 kWh/MT. Aliquot samples were dried at room temperature for particle size analysis.

A portion of each of the Example 1 and Comparative Examples 1-4 after milling are placed in a sealed glass container and allowed to settle under gravity. Example 1 after 7 days failed to display any stratification of the slurry with no apparent settling by eye. Each of comparative examples 1-4 all showed stratification and settling in less than 24 hours.

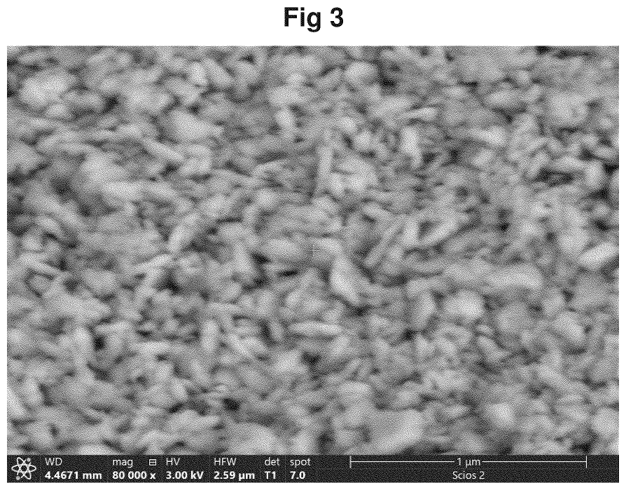

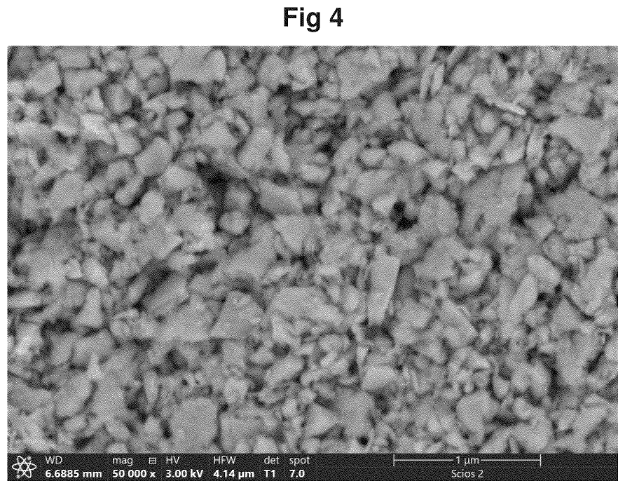

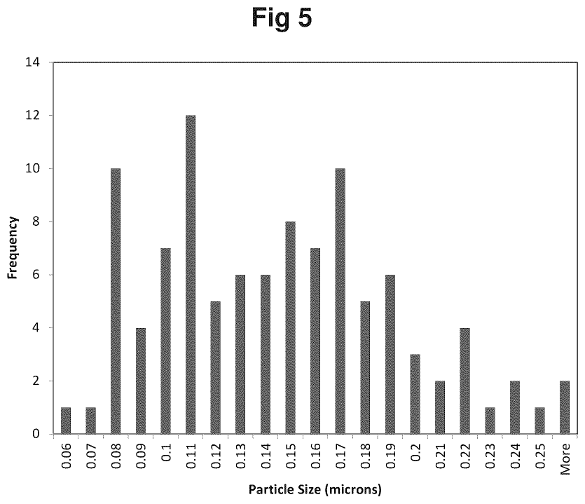

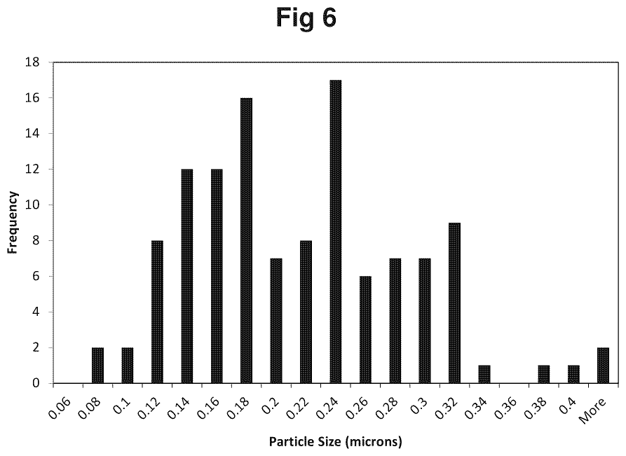

The particle size morphology and particle size using scanning electron microscopy is shown in FIGS. 3-6 for Example 1 and Comparative Example 2. Particle size is determined by randomly selecting 100 particles from the scanning electron micrographs of FIGS. 3 and 4 using the area as determined by Image J open software. The milled silicon of Example 1 has a significantly smaller size than milled silicon of C. Ex. 2 as shown in the size plots in FIGS. 5 and 6.

### Example 2

Example 1 is repeated except that the input milling energy is ˜ 7700 kWh/MT (kilowatt-hours/metric ton). The milled silicon powder has a surface area of 45.52 m²/g. The total oxygen content is 8.7% by weight, which is essentially the same as Comparative Examples 1˜4 having similar surface areas. That is Example 1 and Example 2 have essentially the same oxygen content even though the solvent is comprised of oxygen and has ˜1500 ppm of water compared to the solvent of Comparative Examples 1-4, which have less than 10 ppm water and are hydrocarbons.

X-ray photoelectron spectroscopy measurement of the milled dried silicon powders of Example 2 and Comparative Example 2 are performed on a VG Scientific MKII system using an Al-Kα anode as excitation sources. The pressure inside the chamber is 5*10-8 mbar. Peak fitting was carried out with a Microsoft Excel visual basic program using Voigt profiles together with a Shirley background function.

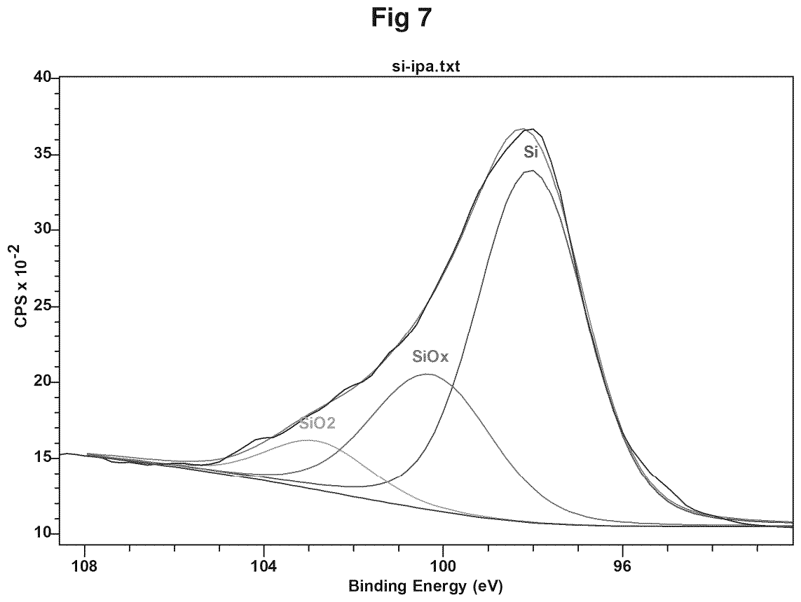

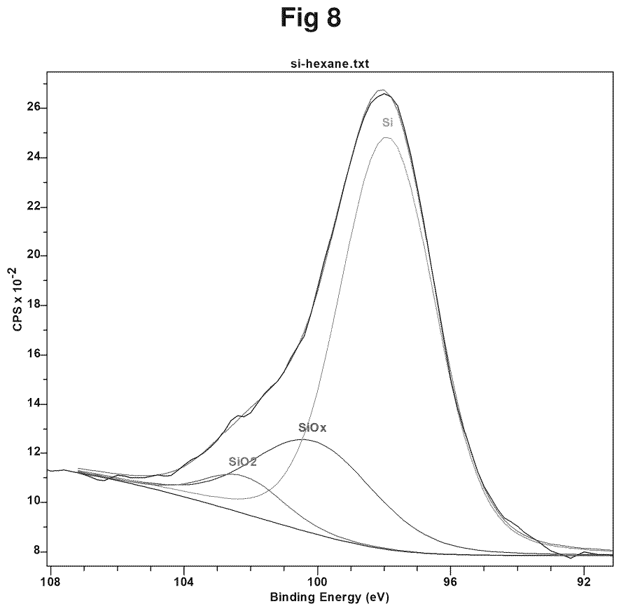

FIG. 7 shows the deconvoluted peak of the peak around 100 eV made up of SiO₂, SIOₓ and Si for Example 2. The ratio of SiOₓ/SiO₂ is about 3.18. FIG. 8 shows the same deconvoluted XPS peak for Comparative Example 2. The ratio of the SiOₓ/SiO₂ is about 3.71 for Comparative Example 2. These results indicate that the total oxygen of the milled silicon is essentially the same for milled silicon powders having the same surface area (i.e., total oxygen per specific surface area is essentially the same), but the chemistry of the oxygen is substantially different as given the by the ratio of SiOₓ/SiO₂ of the milled silicon powder of Example 2 and Comparative Example 2.

### Example 3

The silicon is milled for about 24 hours in acetone at about 15% solids loading in acetone in a high energy vibratory mill (Spex Mill model 8000M) using Tungsten Carbide media inside of an argon filled glovebox. Then, the solvent was allowed to evaporate under mild heating to 70° C. overnight. Upon removal from the glovebox and exposure to air after drying the milled silicon displayed an exothermic event indicative of a substantially different surface chemistry.

TABLE 1

| Example | Solvent | SSA (m²/g) | D10 (nm) | D50 (nm) | D90 (nm) | Oxygen (wt %) |
|---|---|---|---|---|---|---|
| 1 | IPA | 76.54 | 83.35 ± 9.0 | 126.8 ± 9.8 | 212.5 ± 10.5 | 13.97 |
| Comp. 1 | 85% hexane | 49.39 | 113.8 ± 13.2 | 211.0 ± 8.8 | 350.3 ± 33.7 | 9.93 |
| | 15% hexyne | | | | | |
| Comp. 2 | hexane | 49.73 | 122.0 ± 3.3 | 196.0 ± 2.8 | 342.0 ± 26.8 | 8.87 |
| Comp. 3 | toluene | 53.35 | 98.85 ± 13.3 | 167.9 ± 13.3 | 266.3 ± 19.2 | 10.84 |
| Comp. 4 | 85% toluene | 52.07 | 104.5 ± 10.8 | 169.0 ± 2.8 | 316.5 ± 27.9 | 9.26 |
| | 15% hexyne | | | | | |

### Example 4

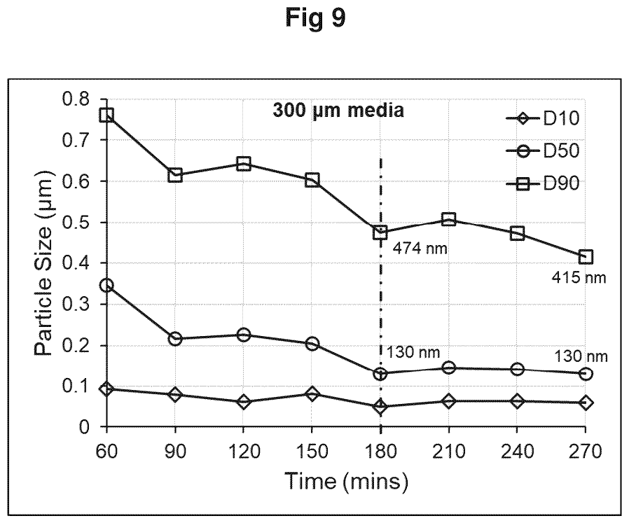

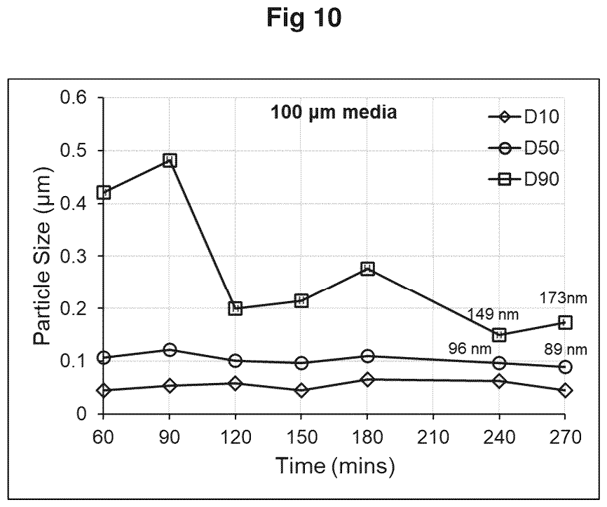

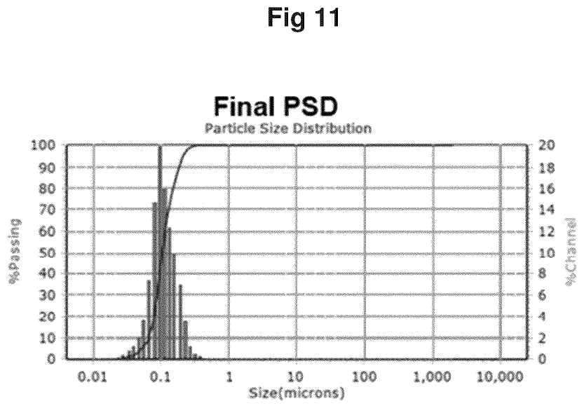

Silicon as described in Example 1 is milled in a Netzsch Minicer mill in benzonitrile (Thermo Scientific) first with 300 micrometer yittria stabilized zirconia milling media for ˜270 minutes at ˜2000 rpm, followed by milling with 100 micrometer yittria stabilized zirconia media for the same time and rpm. The silicon had a solids loading of about 10% weight silicon and the mill was loaded to ˜85% by volume with the milling slurry. The results of the milling is shown in FIGS. 9-11. The D90, D50 and D10 particle size is determined by Microtrac s3500 by diluting in IPA (˜ 0.1 weight solids loading) from samples during the milling and the final particle size distribution is shown in FIG. 11. From this Example, it can be seen that benzonitrile is effective in milling silicon to nanometer size and that cascading milling may be used effectively.

### Examples 5

Silicon is milled in the same manner as Example 4, except that the milling is for ˜270 minutes using only the 100 micrometer milling media and the milling solvent is isopropanol as described in Example 1.

### Example 6

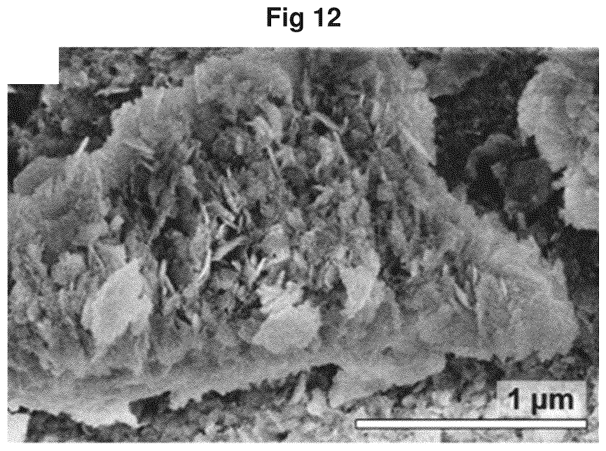

Silicon is milled in the same manner as Example 5, except the milling solvent is benzonitrile. An SEM micrograph of the milled silicon is shown in FIG. 12

### Example 7

Silicon is milled in the same manner as Example 5, except the milling solvent is a solution of 85% isopropanol and 15% benzonitrile by weight. The milled silicon of each Example 5 to 7 resulted in a nanosized silicon having a surface area greater than 30 m2/g, but the silicon of Examples 6 and 7 has a substantially narrow particle size distribution as shown in Table 2.

TABLE 2

| Example | PSD width ((D₉₀-D₁₀)/D₅₀) |
|---|---|
| 5 | 2.87 |
| 6 | 1.45 |
| 7 | 1.14 |

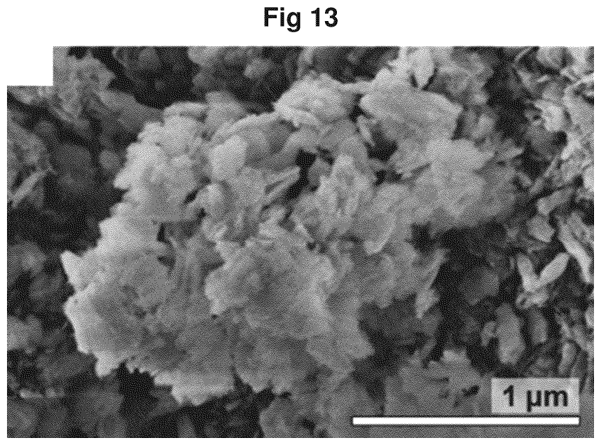

The milled silicon of each Example 5 to 7 resulted in a nanosized silicon having a surface area greater than 30 m²/g, but the silicon of Examples 6 and 7 each have a substantially narrower particle size distribution than Example 5 as shown in Table 2. The solvent for the milled silicon of Examples 6 and 7 was removed by rotary evaporation and then subjected to further drying in a vacuum oven at about 1 Torr pressure for ˜1 and ˜12 hours. The milled silicon of Example 7 is shown in FIG. 13.

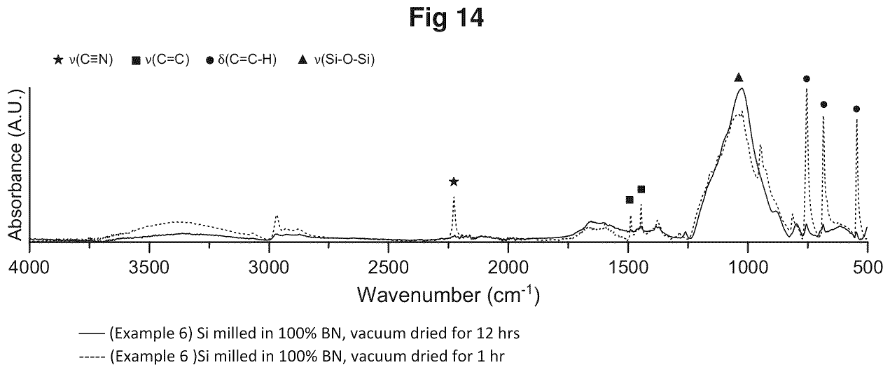

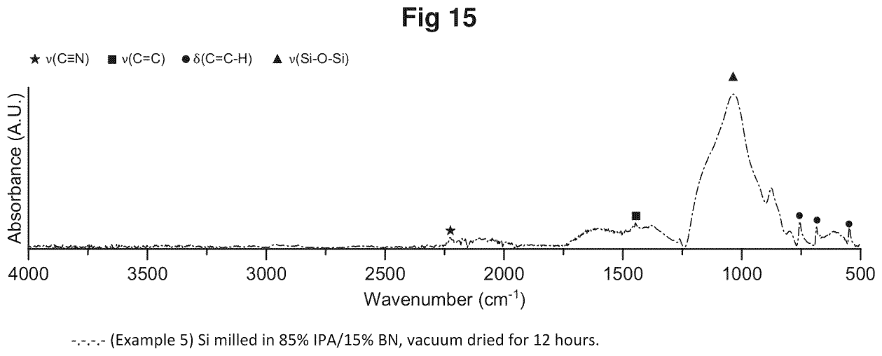

The attenuated total reflectance Fourier transform infrared (ATR-FTIR) spectroscopy of the vacuum dried milled silicon of Example 6 is shown in FIG. 14, where it is evident that the milled silicon still has the benzonitrile chemisorbed on it surface even after 12 hours of vacuum drying. The peak at 3000 wavenumbers initially is suspected to be due to ambient water (hydroxyl) when preparing the milling slurry. The vacuum dried milled silicon of Example 7 is shown in FIG. 15, where it is evident that the benzonitrile is still chemisorbed on the milled silicon surface and any hydroxyl peak expected for the isopropanol is essentially nonexistent. The (ATR-FTIR) spectroscopy is performed on Thermo Scientific ID 5 FTIR with ATR sample attachment.

### Example 8

Silicon is milled in a like manner as Example 6 and the milled slurry is mixed with isopropanol (IPA) to form a spray drying slurry where the spray drying solvent is solution having a 1/1 weight ratio of benzonitrile/IPA. Petroleum pitch having a softening point of about 250° C. (Rain Carbon, grade ZL 250 petroleum pitch), phenolic resin (Plenco, Novolac) are added at a weight ratio of about 1. Timcal C65 carbon (C-NERGY C65 conductive black, Imerys, Switzerland) is also added in an amount of 5 weight percent of the solids (e.g., Si, pitch and phenolic resin). The resultant spray drying slurry has a solids loading of about 10 to 20%. The spray drying slurry is spray dried to form secondary particles using a using a Buchi B-290 Mini spray dryer, equipped with a two-fluid nozzle and an inert gas (nitrogen) loop at about 220° C. inlet temperature and flow rate about 15 ml/min.

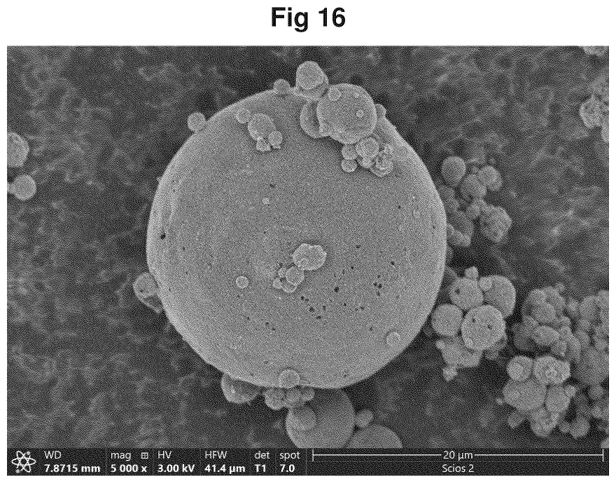

The secondary particles are then pyrolyzed by heating to 1000° C. for one hour under argon with 5% hydrogen at a rate of about 10° C./min to form composite particles. A micrograph of the composite particulates is shown in FIG. 16.

### Example 9

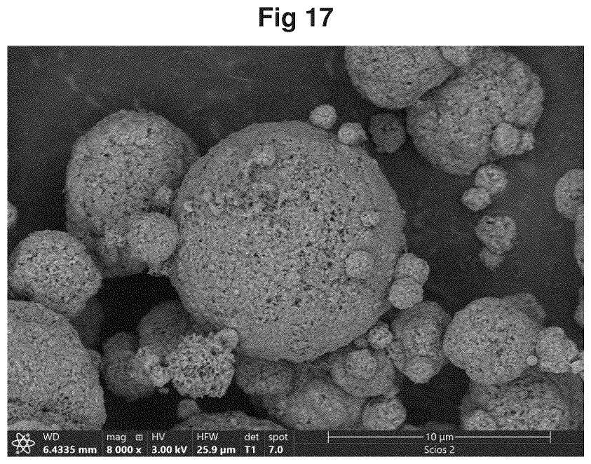

Silicon milled in a like manner as Example 7 and secondary particles and composite particles are made in a like manner as Example 8, except that the spray drying slurry is mixed with further benzonitrile to form a spray drying solvent having a 1/1 weight ratio of IPA/benzonitrile in the same manner as Example 8. The composite particles formed are shown in FIG. 17.

The composite particles of Examples 8 and 9 are made into half cells for battery testing using the following protocol:
Anode
   Anode composition: 75% composite particles, 15% C45 carbon (Imerys), 15% PAA (Mw 450 k g/mol polyacrylic acid)
   Slurry: 25 wt. % solids in NMP
Half coin cell construction (CR2032)
   Anode electrode diameter: 12 mm
   Cathode electrode diameter: 16 mm (Li foil)
   Separator: Celgard 2325
   Electrolyte composition: 1M 90% LiPF₆ in 3EC: 7EMC with 10% FEC
   Electrolyte volume: 90 μL
Cell cycling protocols
   Formation cycle (×2):
      1. CC@0.1 C from OCV to 0.01V
      2. CV@0.01V to 0.2 C
      3. DC@0.1 C to 1.5V
   Post-formation cycles:
      1. CC@0.33 C to 0.01V
      2. CV@0.01V to 0.2 C
      3. DC@0.33 C to 1.5V

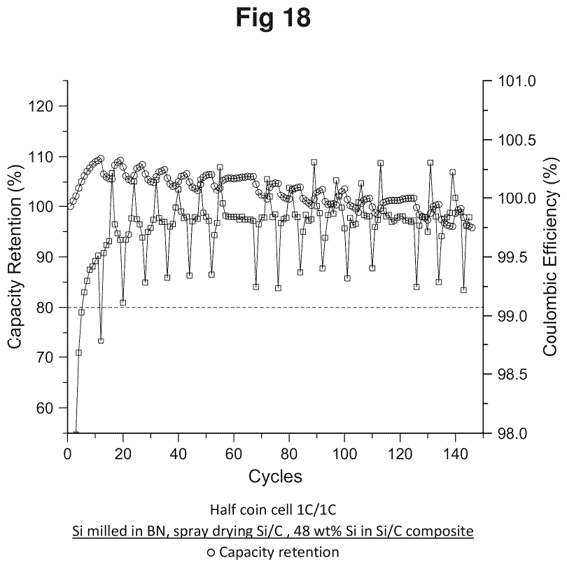

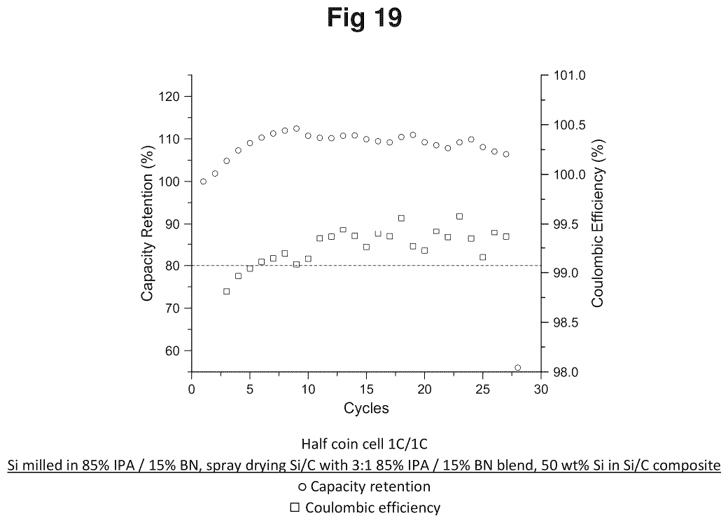

Table 3 shows the characteristics of the composite particles and half cells having anodes made using the composite particles of various lots of composite particles Examples 8 and 9. The typical capacity retention and areal capacity for Example 8 and Example 9 half cells are shown in FIGS. 18 and 19 respectively.

TABLE 3

| Characteristic | Example 8 | Example 9 |
|---|---|---|
| Si wt % in composite particle | 39.3-47.7 | 44.2-49.7 |
| Specific surface area composite particle (m²/g) | 1.4-3.5 | 3.4-10.4 |
| First cycle efficienty (%) | 68.2-71.5 | 75.6-80.1 |
| Specific capacity (mAh/g) | 650-800 | 975-1070 |
| Areal capacity (mAh/cm²) | <1.4 | <2.0 |

The cycling behavior of a representative half cell of Examples 8 and 9 are shown in FIGS. 18 and 19 showing the capacity retention and Coulombic Efficiency.

### Examples 10-18

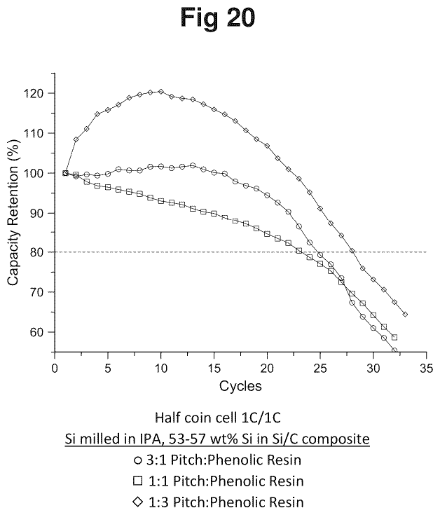

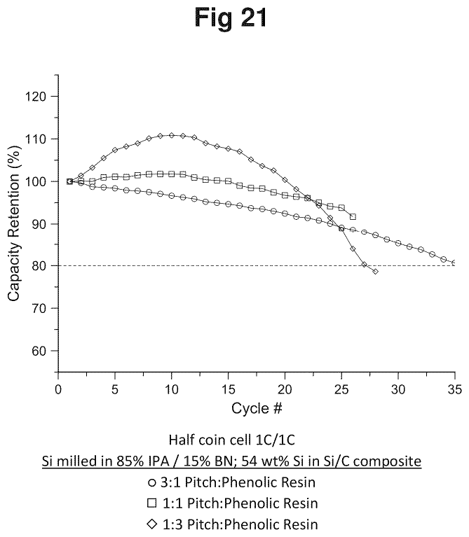

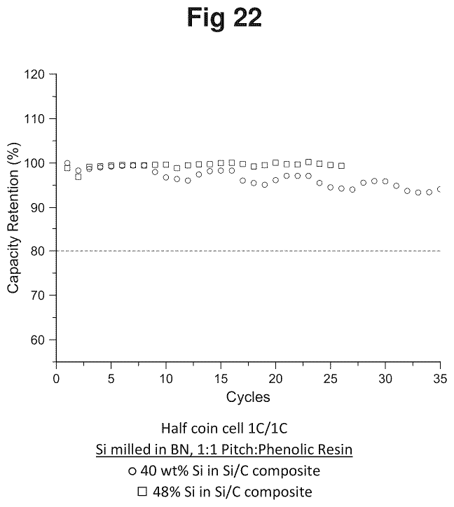

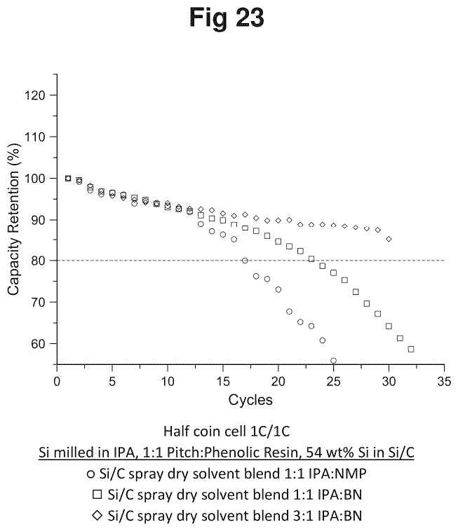

Half cells are made from milled silicon made in a similar fashion as in Examples 5 (IPA milling solvent as indicted in Table 4), Example 6 (benzonitrile “BN” milling solvent) and Example 7 (85% IPA/15% benzonitrile “BN”). The milled silicon has a D₅₀ of about 100 nm. The spray drying solvent is 1/1 weight ratio having carbon forming materials as shown in Table 4. The particle size of the secondary particles had a D₅₀ of about 5 micrometers and the silicon content in the composite particles ranges from about 52% to 57% by weight. The surface area of the composite particles is about 5 m²/g. The half cells are made in the same manner as in Examples 8 and 9. The battery formation is the same except that the cycling is symmetrical (1 C/1 C). FIGS. 20-22 show the effect of changing the pitch/phenolic resin depending in differing milling solvents. From these Figures, the general trend is longer cycle life for carbon formed having a higher amount of carbon forming from pitch. FIG. 23 displays the spray drying solvent effect at a fixed pitch (1/1 pitch/phenolic resin). From this Figure it is apparent that the presence of the BN in the spray dry solvent improves the half cell capacity retention even when the milling solvent is IPA.

TABLE 4

| Example | Pitch/PR weight ratio | Milling solvent |
|---|---|---|
| 10 | 1/2 | BN |
| 11 | 1/1 | BN |
| 12 | 2/1 | BN |
| 13 | 1/2 | IPA |
| 14 | 1/1 | IPA |
| 15 | 2/1 | IPA |
| 16 | 1/2 | IPA/BN (85%/15%) |
| 17 | 1/1 | IPA/BN (85%/15%) |
| 18 | 2/1 | IPA/BN (85%/15%) |

PR: Phenolic resin.

### Examples 19-24

For these Examples, the half cells are made in the same manner as Examples 10 to 18, except that the spray drying solvent is varied as shown in Table 5 and the pitch/phenolic ratio is fixed at 2. From the data it is apparent that the cycle life is longer when the spray drying solvent is comprised of benzonitrile.

### Examples 25-27

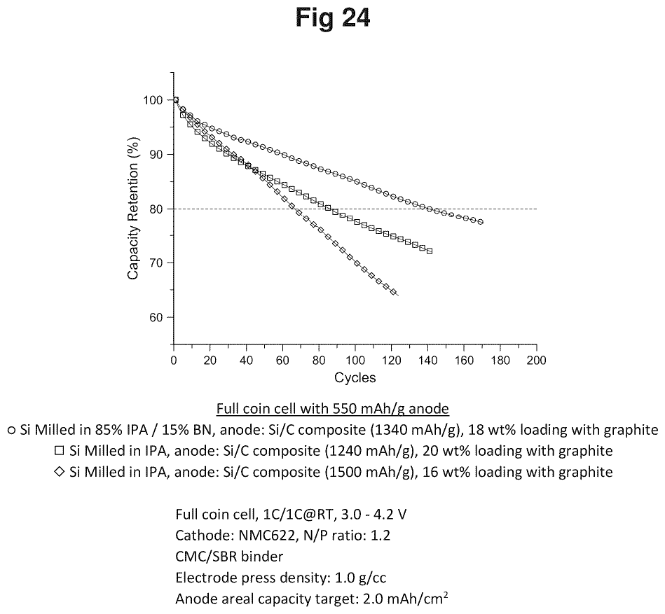

In Example 25-27, a full cell is made as described below. For Example 25, the milled silicon is made in the same manner as Example 7 (IPA/BN milling solvent). For Example 26, the milled silicon is made in the same manner as Example 9 (IPA milling solvent). For each of Examples 25 and 26, the spray drying solvent is 1/1 BN/IPA by weight and the Pitch/Phenolic resin ratio is 1/1 by weight. For Example 27, the milled silicon is made in the same manner as Example 9, but the spray drying solvent is comprise of a 1/1 weight ratio of IPA/NMP (N-Methyl-2-pyrrolidone) with all other things being essentially equal as Examples 25 and 26 (i.e., the silicon is not exposed to a nitrile). The pyrolysis conditions are as described in Example 8 to form the composite particles. The anode capacity is about 550 mAh/g. The anode composition is as described below. The capacity retention is shown in FIG. 24. From this Figure, it is apparent that a longer cycle life is realized when the milling solvent and spray drying solvent is comprised of a nitrile (Examples 25 and 26 compared to Example 27). It is also apparent that improvements in cycle life may be realized when the spray drying solvent is comprised of a nitrile when the milled silicon was milled in an alcohol in the absence of a nitrile (Example 26 compared to Example 27).

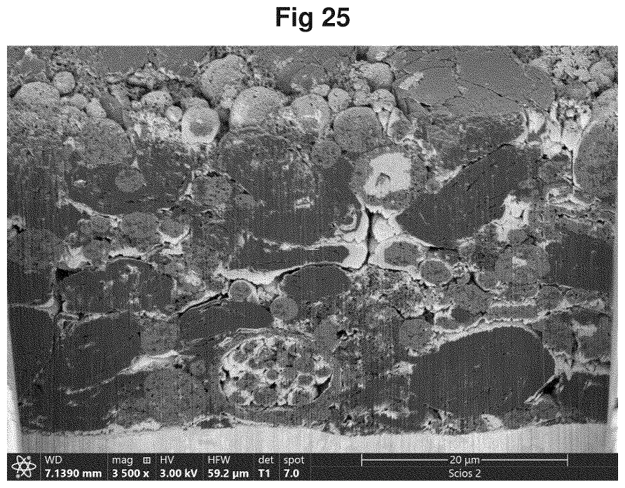

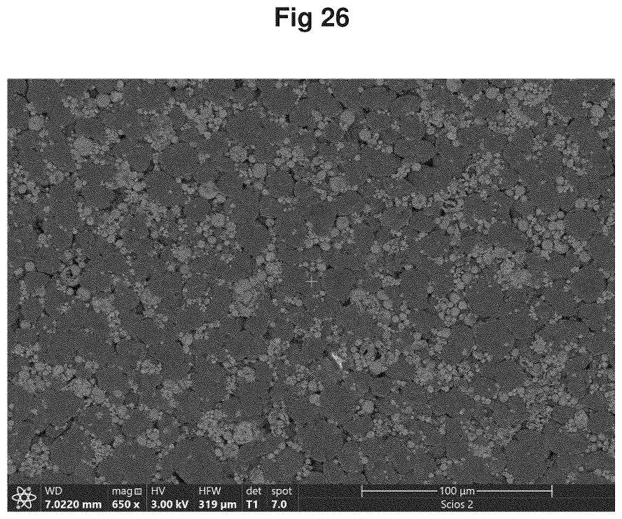

FIGS. 25 and 26 show a scanning electron micrographs of a cross-section and top of the anode displaying the retention of the composite particle shape and morphology and the size difference between the composite particles and the spherical graphite as well as the binder used to make the anode.

Full Cell construction and testing:
Composite particles cell anode (with Graphite)
   Anode Composition: 10-20% Composite particles, 72-82% Graphite, 3% Timcal C45 carbon, 2% CMC, 3% SBR (styrene butadiene rubber)
   Slurry: 40 wt. % solids in H₂O
Cathode composition
   Cathode chemistry: NMC622
Full coin cell construction (CR2032)
   Anode electrode diameter: 15 mm
   Cathode electrode diameter: 12 mm
   Separator: Celgard 2325
   Electrolyte: 1M 90% LiPF₆ in 3EC: 7EMC with 10% FEC and 1% LiP₂OF₂
   Electrolyte volume: 90 μL
Cell cycling protocols
   Formation cycles A (×2):
      1. CC@0.1 C from OCV to 4.2V
      2. CV@4.2V to 0.05 C
      3. DC@0.1 C to 2.7V
   Formation cycles B (×2):
      1. CC@0.1 C to 4.2V
      2. CV@4.2V to 0.05 C
      3. DC@0.1 C to 3.1V
   Post-formation cycles:
      1. CC@0.33 C to 4.2V
      2. CV@4.2V to 0.05 C
      3. DC@0.33 C to 3.0V

TABLE 5

| | Spray Drying Solvent | | Cycles at 80% |
|---|---|---|---|
| Example | (BN/IPA wt. ratio) | Milling solvent | Capacity |
| 19 | 2/1 | IPA/BN (85%/15%) | 30 |
| 20 | 2/1 | IPA | 30 |
| 21 | 1/1 | IPA | 25 |
| 22 | 1/1 | IPA/BN (85%/15%) | 20 |
| 23 | 1/2 | IPA/BN (85%/15%) | 28 |
| 24 | 1/2 | IPA | 18 |

1. (canceled)

2. (canceled)

3. (canceled)

4. (canceled)

5. (canceled)

6. A composition comprising a stable dispersion comprised of particulates comprised of silicon having a chemisorbed nitrile dispersed in a solvent comprised of a polar protic solvent, polar a protic solvent or combination thereof and having a dielectric constant of at least 10, a petroleum pitch and phenolic resin dissolved in the solvent and in the absence of a surfactant.

7. The composition of claim 6, wherein the pitch/phenolic resin weight ratio is from 5/1 to 1/3.

8. The composition of claim 6, wherein the solvent is comprised of a nitrile and an alcohol.

9. A secondary particle comprised of particulates comprised of silicon having a chemisorbed aromatic nitrile and a specific surface area of at least 30 m2/g to 200 m2/g distributed within a resinous matrix comprised of a soft carbon forming material and a hard carbon forming material at a weight ratio of the soft carbon forming material/hard carbon forming material of 5/1 to 1/1.

10. The secondary particle of claim 9, wherein the secondary particle has a D90 particle size of at most 20 micrometers, a D10 of at least 1 micrometer and a D50 of 5 to 10 micrometers.

11. A method of forming a secondary particle comprising,
(i) mixing particulates comprised of silicon and a carbon forming material dissolved in a spray drying solvent comprise of a nitrile to form a spray drying slurry, wherein the carbon forming material is comprised of a soft carbon forming material and a hard carbon forming material,
(ii) atomizing the spray drying slurry and removing the spray drying slurry to form the secondary particles.

12. The method of claim 11, wherein the particulates comprised of silicon have a chemisorbed nitrile.

13. The method of claim 11, wherein the spray drying solvent is comprised of an alcohol.

14. The method of claim 11, wherein the soft carbon forming material is comprised of petroleum pitch.

15. The method of claim 14, wherein the petroleum pitch has a softening temperature from 225° C. to 275° C.

16. The method of claim 11, wherein the soft carbon forming material/hard carbon forming material is a ratio of 5/1 to 1/3.

17. A secondary particle comprised of particulates comprised of silicon embedded in a resin matrix comprised of a carbon forming material, the particulates comprised of silicon having a surface area of 30 m²/g to 200 m²/g and an amount of oxygen by weight percent to surface area by m²/g from 0.300 to about 0.100 and an aromatic chemisorbed nitrile.

18. The secondary particle of claim 17, wherein the carbon forming material is comprised of a soft carbon forming material and a hard carbon forming material.

19. The secondary particle of claim 18, wherein the soft carbon forming material is comprised of a petroleum pitch.

20. The secondary particle of claim 19, wherein the petroleum pitch has a softening temperature from 225° C. to 275° C.

21. The secondary particle of claim 17, wherein the soft carbon forming material/hard carbon has a weight ratio of 5/1 to 1/3.

22. The secondary particle of claim 17, wherein the hard carbon forming material is comprised of a phenolic resin.

23. The secondary particle of claim 17, wherein secondary particle has a D90 particle size of at most 20 micrometers, a D10 of at least 1 micrometer and a D50 of 5 to 10 micrometers.

24. A method of forming a silicon-carbon composite particle comprising heating the secondary particle of claim 17 to a pyrolysis temperature that carbonizes the carbon forming material to form the silicon-carbon composite particle, the pyrolysis temperature being 800° C. to 1500° C.

25. (canceled)

26. (canceled)

27. (canceled)

28. An anode comprised of the composite particle made by the method of claim 24.
